(19) United States
(12) Patent Application Publication
(10) Pub. No.: US 2015/0220698 A1
(43) Pub. Date: Aug. 6, 2015

(54) SYSTEMS AND METHODS FOR DETERMINING SECONDARY HYPERPARATHYROIDISM RISK FACTORS

(71) Applicant: AbbVie Inc., North Chicago, IL (US)

(72) Inventors: Christos Argyropoulos, Alburquerque, NM (US); Konstantinos Xynos, Park Ridge, IL (US)

(21) Appl. No.: 14/612,109

(22) Filed: Feb. 2, 2015

Related U.S. Application Data
(60) Provisional application No. 61/935,593, filed on Feb. 4, 2014.

(51) Int. Cl. G06F 19/00

(52) U.S. Cl. CPC G06F 19/3431; G06F 19/322; G06F 19/3437; G06F 19/345

(57) ABSTRACT

A computer-implemented method for determining at least one secondary hyperparathyroidism risk factor (“SHPT”) for a patient is implemented using a risk evaluation computer system in communication with a memory. The method includes receiving a plurality of demographic data associated with a patient from a mobile computing device, receiving a concentration of a renal filtration marker associated with the patient from the mobile computing device, and determining at least one SHPT risk factor for the patient based on the plurality of demographic data and the concentration of the renal filtration marker using at least one estimating equation, the SHPT risk factor indicating a likelihood that the patient has SHPT.

### CROSS REFERENCE TO RELATED APPLICATIONS

This application claims priority to U.S. Provisional Patent Application Ser. No. 61/935,593, filed Feb. 4, 2014, which is incorporated herein by reference in its entirety.

### BACKGROUND

This description relates to medical risk factors, and more particularly, to methods and systems for evaluating risk factors associated with secondary hyperparathyroidism.

Secondary hyperparathyroidism (“SHPT”) is a condition in which parathyroid glands produce excessive amounts of parathyroid hormone (PTH). SHPT occurs when the parathyroid gland of an individual experiences a deficiency of calcium (“hypocalcaemia”) or a deficiency of vitamin D along with an excess of phosphorous and abnormal kidney function such as Chronic Kidney Disease (“CKD”). Although SHPT may lead to serious complications, diagnosis may be difficult due the complexity of accurately assessing risk factors associated with the condition.

### BRIEF DESCRIPTION OF THE DISCLOSURE

In one aspect, a computer-implemented method for determining at least one secondary hyperparathyroidism risk factor (“SHPT”) for a patient is provided. The method is implemented using a risk evaluation computer system in communication with a memory. The method includes receiving a plurality of demographic data associated with a patient from a mobile computing device, receiving a concentration of a renal filtration marker associated with the patient from the mobile computing device, and determining by the risk evaluation computer system at least one SHPT risk factor for the patient based on the plurality of demographic data and the concentration of the renal filtration marker using at least one estimating equation, the SHPT risk factor indicating a likelihood that the patient has SHPT.

In another aspect, a risk evaluation computer system for determining secondary hyperparathyroidism risk factors (“SHPT”) is provided. The risk evaluation computer system includes a memory for storing data and a processor in communication with the memory. The processor is configured to receive a plurality of demographic data associated with a patient from a mobile computing device, receive a concentration of a renal filtration marker associated with the patient from the mobile computing device, and determine at least one SHPT risk factor for the patient based on the plurality of demographic data and the concentration of the renal filtration marker using at least one estimating equation, the SHPT risk factor indicating a likelihood that the patient has SHPT.

In another aspect, a computer-readable storage device having processor-executable instructions embodied thereon, for determining secondary hyperparathyroidism (“SHPT”) risk factors on a mobile computing device is provided. When executed by a mobile computing device, the processor-executable instructions cause the computing device to receive a plurality of demographic data associated with a patient, receive a concentration of a renal filtration marker associated with the patient, transmit the plurality of demographic data and the concentration of the renal filtration marker to a risk evaluation computer system, and receive at least one SHPT risk factor for the patient, the SHPT risk factor indicating a likelihood that the patient has SHPT.

In yet another aspect, a computer-readable storage device, having processor-executable instructions embodied thereon, for determining secondary hyperparathyroidism (“SHPT”) risk factors on a risk evaluation computer system is provided. When executed by a risk evaluation computer system, the processor-executable instructions cause the risk evaluation computer system to receive a plurality of demographic data associated with a patient, receive a concentration of a renal filtration marker associated with the patient, and determine at least one SHPT risk factor for the patient based on the plurality of demographic data and the concentration of the renal filtration marker associated with the patient, the SHPT risk factor indicating a likelihood that the patient has SHPT.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a simplified block diagram of an example system used to determine secondary hyperparathyroidism risk factors including an example risk evaluation computer system and a plurality of mobile computing devices in accordance with one example embodiment of the present disclosure;

FIG. 2 is a block diagram of a server system such as risk evaluation computer system, used for determining secondary hyperparathyroidism risk factors, as shown in the system of FIG. 1;

FIG. 3 is a block diagram of a user system, such as the mobile computing device of FIG. 1, used for determining secondary hyperparathyroidism risk factors, as shown in the system of FIG. 1;

FIG. 4 is an example data flow diagram illustrating the determination of secondary hyperparathyroidism risk factors using the system of FIG. 1,

FIG. 5 is an example method for determining secondary hyperparathyroidism risk factors performed by the risk evaluation computer system and using the system of FIG. 1;

FIG. 6 is an example method for determining secondary hyperparathyroidism risk factors performed by a mobile computing device and using the system of FIG. 1;

FIG. 7 is a diagram of components of one or more example computing devices that may be used in the system shown in FIG. 1; and

FIG. 8-24 are screenshots of an example software for determining secondary hyperparathyroidism risk factors using a mobile computing device as shown in FIG. 3 in communication with the risk evaluation computer system of FIG. 2.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of implementations refers to the accompanying drawings. The same reference numbers in different drawings may identify the same or similar elements. Also, the following detailed description does not limit the claims.

The system described herein is configured to assist in the evaluation of secondary hyperparathyroidism (“SHPT”) by providing a screening tool to identify patients with an elevated likelihood of SHPT. More specifically, the system is configured to determine at least one SHPT risk factor for a patient. SHPT is a condition in which the parathyroid glands produce excessive amounts of parathyroid hormone (PTH). SHPT occurs when the parathyroid gland of an individual experiences a deficiency of calcium (“hypocalcaemia”) or a deficiency of vitamin D (“Hypovitaminosis D”) along with an excess of phosphorous and abnormal kidney function such as Chronic Kidney Disease (“CKD”). SHPT may be associated with serious complications for a patient. Such complications may include, for example, bone disease, bone fractures, increased mortality from cardiac disease, accelerated decline in kidney function, and deposition of calcium deposits in vascular tissue. Although SHPT may lead to such serious complications, diagnosis may be difficult due the complexity of accurately assessing risk factors associated with the condition.

Although at least some current clinical guidelines specify that physicians treating patients with CKD should screen their patients for SHPT with biochemical testing, such screening has technical and financial complexities. In some cases, such complexities in testing for elevated PTH reduce the frequency of ordering the screening. Accordingly, a preliminary screening tool such as the system and method described herein is desirable. More specifically, the systems and methods described herein prioritize patients with an increased probability of SHPT for further biochemical testing and are accordingly of practical clinical utility.

At least some diagnostics of risk factors associated with SHPT may include measurement errors. For example, the rate of glomerular filtration rate (“GFR”), an index of renal function, may serve as an indicator of the risk of SHPT. However, measurement of GFR may include measurement errors and accordingly a discrepancy may exist between an estimated GFR (“eGFR”) and an actual GFR or iothalamate GFR (“iGFR”). Similarly, the blood concentration of parathyroid hormone (“PTH”) is another important indicator of the risk of SHPT. Notably, the nature of SHPT is that PTH and iGFR are at least somewhat correlated. Measurement of PTH may similarly include measurement errors and accordingly a discrepancy may exist between a first estimated PTH (“ePTH”) and a second estimated PTH (“yPTH”). Medical professionals evaluating patients accordingly benefit from greater confidence that an estimated risk factor such as eGFR or ePTH is approximately equal to the actual risk factor such as iGFR or yPTH. Moreover, whenever an estimate is used to substitute for an actual measurement, the incorporation of uncertainty into the estimate may prevent a medical professional from taking action with the presumption that estimate has no uncertainty. Accordingly, the system and method described herein uses a measurement error model to address potential discrepancies between a true measurement (such as iGFR) and an estimated measurement (such as actual GFR).

Accordingly, the relationship between an actual measurement, an estimate, and an error may be described in this equation: Actual Measurement=Formula Estimate+Error. Alternately, the same concept may be expressed using logarithms to simplify the calculations in this equation: Log Actual Measurement=Log Formula Estimate+Error. Error is described as a residual random influence with a statistical distribution that can be characterized by a bias and a variance parameter. The bias and the variance parameter of the measurement error model can be estimated from datasets in which results from an estimating equation (used to determine an estimate) is compared to actual measurements.

In the example embodiment, the methods described herein are performed by a risk evaluation computer system in communication with a mobile computer device. Accordingly, each of the risk evaluation computer system and the mobile computing device are configured to perform steps to facilitate the determination of risk factors associated with SHPT. Further, in at least some examples, the methods described herein are performed by other systems or only one system.

A first method described herein is performed by a risk evaluation computer system and includes (a) receiving, from a mobile computing device, a plurality of demographic data associated with a patient, (b) receiving, from the mobile computing device, a concentration of a renal filtration marker associated with the patient, and (c) determining, by the risk evaluation computer system, at least one SHPT risk factor for the patient based on the plurality of demographic data and the concentration of the renal filtration marker associated with the patient using at least one estimating equation, the SHPT risk factor indicating a likelihood that the patient has SHPT.

A second method described herein is performed by a mobile computing device and includes (a) receiving a plurality of demographic data associated with a patient, (b) receiving a concentration of a renal filtration marker associated with the patient, (c) transmitting the plurality of demographic data and the concentration of the renal filtration marker to a risk evaluation computer system, and (d) receiving at least one SHPT risk factor for the patient, the SHPT risk factor indicating a likelihood that the patient has SHPT.

In the example embodiment, a user accesses software associated with the determination of SHPT risk factors from a mobile computing device. The software facilitates the input of information relevant to the evaluation of a patient for SHPT risk factors, the configuration of analysis performed regarding such inputted information, interaction and communication with the risk evaluation computer system, receipt of information related to the revaluation of SHPT risk factors from the risk evaluation computer system, and the display of such information. The software may be stored as computer-readable storage on a mobile computing device. In one example, the mobile computing device may store the software “locally” on its local memory as a local application. In another example, the mobile computing device accesses the software from a remote system or a cloud system. The user may be required to enter information such as logon information to interact with the software. Such logon information may facilitate securing the software and related data from individuals who are not suitable providers of healthcare services.

The mobile computing device receives a plurality of demographic data associated with a patient. The plurality of demographic data may include, for example, an age of a patient, a gender of the patient, a race of the patient, and an indication of whether the patient has diabetes. More specifically, the demographic data may include a text entry for the age of a patient. Additionally, the demographic data may include an indication such as a radio box input selecting whether a patient is male or female. The demographic data may also include an indication such as a radio box input selecting the racial categorization most closely associated with the patient. In the example embodiment, the racial categorization requires specifying whether a patient is “African American” or “non-African American.” In other examples, other categorizations may be used to the degree that they are relevant to the evaluation of risk factors associated with SHPT. Accordingly, any demographic data may be received and used if information exists to process the relationship between such demographic data and at least one SHPT risk factor. The demographic data may also include an indication such as a radio box input selecting whether a patient has diabetes or does not have diabetes. Such demographic data is useful in the evaluation of risk factors associated with SHPT because at least some values associated with the example data is correlated to higher or lower incidences of SHPT. In other examples, the demographic data may include any other demographic information that may inform the evaluation of a risk factor for SHPT.

The mobile computing device also receives a concentration of a renal filtration marker associated with a patient. The concentration of a renal filtration marker indicates the concentration of one or more internal renal filtration markers in the blood, plasma, or serum of the patient. Renal filtration markers are small organic molecules or proteins that are generated as a bioproduct of the regular biochemical processes that take place in the body and are subsequently removed from the body by the kidneys. Renal filtration markers may include, for example, creatinine, cystatin-C, beta trace proteins, beta-2-microglobulin, and retinol binding proteins. In the example embodiment, the renal filtration marker is creatinine. Creatinine is a byproduct created during the breakdown of creatine phosphate in human muscle. Creatinine is mainly removed from blood by glomerular filtration performed by kidneys. If such glomerular filtration in the kidney is deficient, creatinine blood levels rise. Accordingly, a creatinine level in blood correlates with the glomerular filtration rate (GFR). Creatinine levels may also be used along with the plurality of demographic data (age, gender and racial characterization) to calculate an estimated GFR (eGFR). As discussed above and herein, GFR and eGFR are useful for the evaluation of risk factors associated with SHPT. In the example embodiment, the user may input the creatinine level in a numeric format. More specifically, the user inputs the creatinine concentration in milligrams per deciliter. As any renal filtration marker may indicate the rate of renal filtration, in alternative embodiments, concentrations of any suitable renal filtration may be used including, for example and without limitation, cystatin-C, beta trace proteins, beta-2-microglobulin, and retinol binding proteins.

In at least some embodiments, mobile computing device receives a first request for the calculation of at least one first laboratory test estimate. In one embodiment, the first request is a request for the calculation of an index of renal function and a first degree of uncertainty. In at least one example, the first request is, more specifically, a request for the calculation of at least one glomerular filtration rate. In such examples, the glomerular filtration rate may include an iothalamate GFR (iGFR), and an estimated glomerular filtration rate (eGFR). As used herein, iGFR and eGFR may accordingly function as an SHPT risk factor and be reviewed by a healthcare provider to determine the risk of SHPT for the patient. The first degree of uncertainty represents a predicted probability of the accuracy of the first laboratory test estimate. This degree of uncertainty is estimated from the Berkson measurement error model that relates eGFR to iGFR. As used herein, the Berkson measurement error model refers to a model of identifying and classifying the error of the CKD Epi formula to account for such erroneous estimates in calculations. The CKD Epi formula is described below. The Berkson measurement error model postulates that actual GFR as measured by the iothalamate tracer technique (log “iGFR”) is related to the CKD Epi estimate (“eGFR”) by a lognormal error distribution that incorporates a bias (b) and a variance parameter (v) as stated in Equation 1 or equivalently stated in Equation 2:

$$\begin{matrix}\frac{eGFR}{iGFR} ∼ Lognormal ( - b , v ) & Equation 1 \\ log ( iGFR ) ∼ Normal ( log ( eGFR ) + b , v ) & Equation 2\end{matrix}$$

The bias and variance parameters have been estimated from publically available research about the probability that a given eGFR is within 20% and 30% of the iGFR using the mathematical properties of the lognormal distribution, the normal (Gaussian) distribution, and non-linear regression. Such research is published by Inker L A et al., in Estimating Glomerular Filtration Rate from Serum Creatinine and Cystatin C N Engl J Med 2012; 367:20-9. Non-linear regression is carried out for eGFR values less than 60, 60-89 and >90 ml/min/1.73 m2 and proceeds by finding the values of b and v maximizing the statistical likelihood of Equation 3 and Equation 4:

∫_{1-0.2}^{1+0.2}p_{Lognormal}(x|−b,v)dx=∫_{log(1-0.2)}^{log(1+0.2)}p_{Normal}(x|−b,v)dx=y₁ Equation 3:

∫_{1-0.3}^{1+0.3}p_{Lognormal}(x|−b,v)dx=∫_{log(1-0.3)}^{log(1+0.3)}p_{Normal}(x|−b,v)dx=y₂ Equation 4:

In Equations 3 and 4, p_{Lognormal}(x|−b, v) and p_{Normal}(x|−b, v) are the probability density functions of the Lognormal and Normal distributions with parameters −b and v that are known in art. The values y₁ and y₂ assume the following values according to the value of the eGFR as shown in the table below (Table 1):

TABLE 1
eGFR (ml/min/1.73 m2)

| | <60 | 60-89 | >90 |
|---|---|---|---|
| y₁ | 0.372 | 0.311 | 0.265 |
| y₂ | 0.166 | 0.102 | 0.078 |

The bias and variance parameters estimated as such are given in the table below (Table 2):

TABLE 2
eGFR (ml/min/1.73 m2)

| | <60 | 60-89 | >90 |
|---|---|---|---|
| Bias (b) | 0.06395077 | 0.1040000 | 0.0741525 |
| Variance (v) | 0.22281988 | 0.1805216 | 0.1735347 |

In some embodiments, mobile computing device also receives a second request for the calculation of at least one second laboratory test estimate. In one embodiment, the second request is a request for the calculation of a risk factor associated with secondary hyperparathyroidism and a second degree of uncertainty. In at least one example, the second request is, more specifically, a request for the calculation of at least one of a first estimated calculation of a blood concentration parathyroid hormone (ePTH) and a second estimated blood concentration of parathyroid hormone (yPTH). As used herein, ePTH and yPTH may accordingly function as an SHPT risk factor and be reviewed by a healthcare provider to determine the risk of SHPT for the patient. The ePTH is the estimated level of the parathyroid hormone that the app computes based on applying a Berkson measurement error model for the eGFR and a spline model for the relationship between iGFR, received patient data (including demographic data), and PTH. yPTH reflects a predicted level of the parathyroid hormone based on the use of a statistical error model on ePTH. The second degree of uncertainty represents a predicted probability of the accuracy of the second laboratory test estimate. As used herein, the statistical error model refers to a model of identifying and classifying measurement error to account for such errors in the calculations.

In at least some examples, the user may want to determine whether a patient has a particular likelihood of a particular value (or range of values) for an SHPT risk factor. For example, depending upon the opinion, personal history, and analysis of the user, the user may be concerned with whether the SHPT risk factor is likely to be above or below a certain value. This concern may also depend upon previous interaction with and analysis of the patient. Accordingly, the mobile computing device receives a third request for a confidence analysis. The confidence analysis is a range of values that the SHPT risk factor may be associated with for a particular degree of confidence. The third request includes a confidence probability value representing the degree of confidence. In other words, a user requests to know what the range of an SHPT risk factor is for a given confidence level.

In a second example, the user may want to know whether the SHPT risk factor is likely to exceed or fall below a particular threshold. The mobile computing device additionally receives a fourth request for a threshold analysis. The fourth request includes a first prediction value. The fourth request is a request for the probability that an SHPT risk factor exceeds or falls below the first prediction value. In some examples, the fourth request may also include an indicator that the SHPT risk factor only exceed or fall below the first prediction value. For example, a user may provide that they only want to know the probability that a particular value for an SHPT risk factor exceeds a threshold or falls below a threshold.

The mobile computing device further transmits all received data to a risk evaluation computer system. In the example embodiment, the mobile computing device transmits the plurality of demographic data and the concentration of the renal filtration marker associated with the patient. In the example embodiment, such data is transferred securely using a network such as the Internet. Accordingly, the risk evaluation computer system resultantly receives such data including at least the plurality of demographic data and the concentration of the renal filtration marker associated with the patient. In at least some examples, the risk evaluation computer system receives the first request, the second request, the third request, the fourth request, the first prediction value, and the second prediction value.

The risk evaluation computer system determines at least one SHPT risk factor for the patient based on the plurality of demographic data and the concentration of the renal filtration marker using at least one estimating equation. In the example embodiment, the SHPT risk factor is eGFR. In alternative embodiments, the SHPT risk factor may include iGFR, ePTH, or yPTH, as described above and herein. The estimating equation may include any suitable estimating equation. In the example embodiment, the CKD Epi formula is used to calculate eGFR. The CKD Epi formula is known in the art and depends upon the relationship between eGFR and serum creatinine is described by a linear spline with a single knot, whose location is determined by gender. In alternative embodiments, the estimating equation may be used to determine ePTH and yPTH and may further include the use of a simulation algorithm such as the Markov Chain Monte Carlo stochastic algorithm, described below.

In some examples, the risk evaluation computer system determines at least one SHPT risk factor by determining a first laboratory test estimate for renal function and a first degree of uncertainty. Such determination is achieved by processing the plurality of demographic data, the concentration of the renal filtration marker, and the first request, using at least one estimating equation. In the example embodiment, using the estimating equation includes using a Berkson measurement error model. In the example embodiment, the estimating equation is the CKD Epi formula. In at least some examples, the risk evaluation computer system determines at least one of a log glomerular filtration rate calculation, a log estimated glomerular filtration rate simulation, an expected value calculation, an uncertainty calculation, and a threshold calculation.

In further examples, the risk evaluation computer system also determines SHPT risk factors by determining a second laboratory test estimate and a second degree of uncertainty. Such determination is achieved by processing the plurality of demographic data, the second request, the first laboratory test estimate, and the first degree of uncertainty using at least one simulation algorithm. In the example embodiment, the simulation algorithm is a Markov Chain Monte Carlo stochastic simulation algorithm. The Markov Chain Monte Carlo stochastic algorithm may include any algorithms for sampling from probability distributions based on constructing a Markov chain that has the desired distribution as its equilibrium distribution. The state of the chain after a large number of steps is then used as a sample of the desired distribution. The quality of the sample improves as a function of the number of steps. In at least some examples, the risk evaluation computer system determines a predicted parathyroid hormone level, an estimated parathyroid hormone level, an expected value calculation, an uncertainty calculation, and a threshold calculation.

In examples wherein the mobile computing device receives prediction values and requests for confidence or threshold analyses, the risk evaluation computer system performs such confidence and threshold analyses. More specifically, the risk evaluation computer system determines a third response for a confidence analysis including a range of values for an SHPT risk factor associated with the confidence probability value provided in the third request. The risk evaluation computer system also determines a fourth response for a threshold analysis including a probability that the SHPT risk factor exceeds or falls below the first prediction value provided in the fourth request.

The risk evaluation computer system also provides the at least one SHPT risk factor to the mobile computing device. Accordingly, in some examples, the risk evaluation computer system further provides the first laboratory test estimate and the first degree of uncertainty to the mobile computing device and also provides the second laboratory test estimate and the second degree of uncertainty to the mobile computing device. Providing the at least one SHPT risk factor to the mobile computing device represents transmitting such information to the mobile computing device. In the example embodiment, the information is transmitted over a network such as the Internet. Accordingly, in the example embodiment, the mobile computing device receives the at least one SHPT risk factor. In other embodiments, the mobile computing device also receives the first laboratory test estimate and the first degree of uncertainty as well as the second laboratory test estimate and the second degree of uncertainty.

In at least some examples, the risk evaluation computer system also transmits additional information. Such additional information may include the third response for the confidence analysis including a range of values for the SHPT risk factor associated with the confidence probability value provided in the third request. The third response is transmitted in examples where the mobile computing device transmits a third request for a confidence analysis. Such additional information may also include the fourth response for a threshold analysis including a probability that the SHPT risk factor or falls below the first prediction value provided in the fourth request. The fourth response is transmitted in examples where the mobile computing device transmits a fourth request for a threshold analysis.

The mobile computing device displays, to the user, the at least one SHPT risk factor. In some examples, the mobile computing device also displays the first laboratory test estimate and the first degree of uncertainty and the second laboratory test estimate and the second degree of uncertainty. Such information is displayed on at least one display of the mobile computing device. In at least some examples, the mobile computing device also displays at least one of the third and fourth responses.

As used herein, an element or step recited in the singular and proceeded with the word “a” or “an” should be understood as not excluding plural elements or steps, unless such exclusion is explicitly recited. Furthermore, references to “one embodiment” of the subject matter disclosed herein are not intended to be interpreted as excluding the existence of additional embodiments that also incorporate the recited features.

A technical effect of the systems and methods described herein include at least one of (a) reducing inconvenience to patients due to screening of patients for SHPT despite lower probabilities of SHPT; (b) reducing medical resource expenditures due to screening of patients for SHPT despite lower probabilities of SHPT; (c) increasing the likelihood of early detection of SHPT; and (d) increasing the likelihood of earlier treatment of conditions related to SHPT.

The methods and systems described herein may be implemented using computer programming or engineering techniques including computer software, firmware, hardware or any combination or subset thereof, wherein the technical effects may be achieved by performing one of the following steps: (a) receiving a plurality of demographic data associated with a patient; (b) receiving a concentration of a renal filtration marker associated with the patient; (c) determining at least one SHPT risk factor for the patient based on the plurality of demographic data and the concentration of the renal filtration marker using at least one estimating equation, the SHPT risk factor indicating a likelihood that the patient has SHPT; (d) receiving a first request of at least one glomerular filtration rate (GFR) and determining the at least one SHPT risk factor, wherein the at least one SHPT risk factor includes at least one of an iothalamate GFR (iGFR) and an estimated GFR (eGFR); (e) receiving a second request of a parathyroid hormone concentration (PTH) and determining the at least one SHPT risk factor, wherein the at least one SHPT risk factor includes at least one of an estimated PTH (ePTH) and yPTH; (f) determining a first laboratory test estimate for renal function and a first degree of uncertainty by processing the plurality of demographic data, the concentration of the renal filtration marker, and the first request, using at least one estimating equation; (g) determining a second laboratory test estimate and a second degree of uncertainty by processing the plurality of demographic data, the second request, the first laboratory test estimate, and the first degree of uncertainty using at least one simulation algorithm; (h) providing the at least one SHPT risk factor for the patient to the mobile computing device; (i) providing the first laboratory test estimate and the first degree of uncertainty to the mobile computing device and providing the second laboratory test estimate and the second degree of uncertainty to the mobile computing device; (j) receiving a third request for a confidence analysis, wherein the third request includes a confidence probability value and determining a third response for the confidence analysis, wherein the third response is range of values of the at least one SHPT risk factors associated with the confidence probability value; (k) receiving, by the computer system, a first prediction value for the at least one SHPT risk factor, receiving a fourth request for a threshold analysis, wherein the fourth request includes the first prediction value, and determining a fourth response for the threshold analysis, wherein the fourth response includes a threshold probability that the at least one SHPT risk factor exceeds or falls below the first prediction value; (l) receiving a report including a plurality of values for the at least one SHPT risk factor with a probability for each value; (m) receiving at least one of a gender of the patient, a race of the patient, and an indication of whether the patient has diabetes; (n) determining at least one of a log glomerular filtration rate calculation for the patient, a log estimated glomerular filtration rate simulation for the patient, an expected value of the at least one SHPT risk factor, an uncertainty calculation of the at least one SHPT risk factor, and a threshold calculation of the at least one SHPT risk factor; (o) determining at least one of a predicted parathyroid hormone level for the patient, an estimated parathyroid hormone level for the patient, an expected value calculation for the patient, an uncertainty calculation for the patient, and a threshold calculation for the patient; (p) determining a third response for a confidence analysis, wherein the third response is a range of values in which the at least one SHPT risk factor is contained with a given probability; (q) determining a fourth response for a threshold analysis, wherein the fourth response is the probability that the at least one SHPT risk factor exceeds or falls below the first prediction value; (r) determining a fifth response for a confidence analysis, wherein the fifth response is a range of values in which the at least one SHPT risk factor is contained with a given probability; and (s) determining a sixth response for a threshold analysis, wherein the sixth response is the probability that the at least one SHPT risk factor exceeds or falls below the second prediction value.

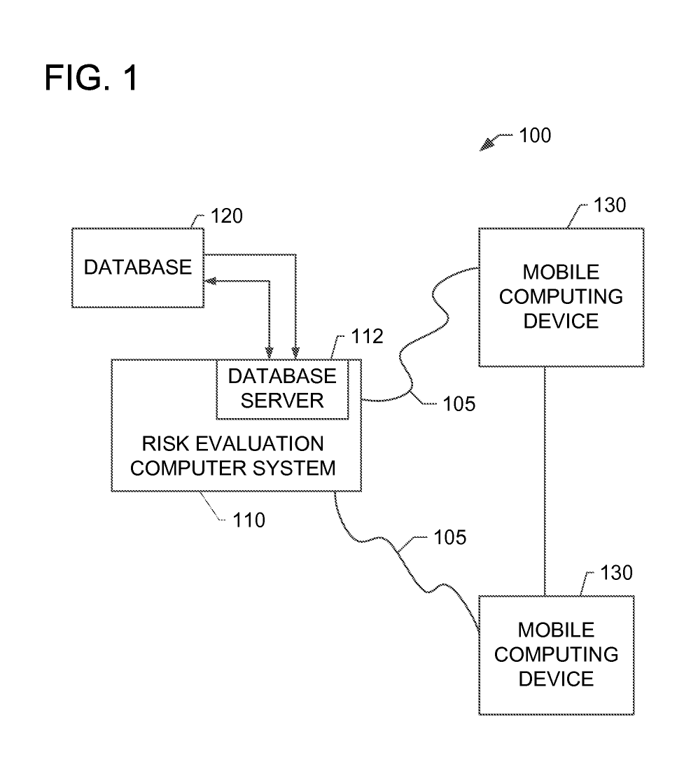

FIG. 1 is a simplified block diagram of an example system 100 used to evaluate secondary hyperparathyroidism risk factors including an example risk evaluation computer system 110 and a plurality of mobile computing devices 130 in accordance with one example embodiment of the present disclosure. In the example embodiment, system 100 is used for (a) receiving, from a mobile computing device, a plurality of demographic data associated with a patient, (b) receiving, from the mobile computing device, a concentration of a renal filtration marker associated with the patient, and (c) determining at least one SHPT risk factor for the patient based on the plurality of demographic data and the concentration of the renal filtration marker using at least one estimating equation, the SHPT risk factor indicating a likelihood that the patient has SHPT, as described herein. In other embodiments, the applications may reside on other computing devices (not shown) communicatively coupled to system 100, and may provide other methods of evaluating risk factors for conditions including SHPT using system 100.

More specifically, in the example embodiment, system 100 includes a risk evaluation computer system 110, and a plurality of client sub-systems, also referred to as mobile computing devices 130, connected to risk evaluation computer system 110. In one embodiment, mobile computing devices 130 are computers including a web browser, such that risk evaluation computer system 110 is accessible to mobile computing devices 130 using the Internet. Mobile computing devices 130 are interconnected to the Internet through many interfaces including a network 105, such as a local area network (LAN) or a wide area network (WAN), dial-in-connections, cable modems, special high-speed Integrated Services Digital Network (ISDN) lines, and RDT networks. Mobile computing devices 130 could be any device capable of interconnecting to the Internet including a web-based phone, PDA, or other web-based connectable equipment.

A database server 112 is connected to database 120, which contains information on a variety of matters, as described below in greater detail. In one embodiment, centralized database 120 is stored on risk evaluation computer system 110 and can be accessed by potential users at one of mobile computing devices 130 by logging onto risk evaluation computer system 110 through one of mobile computing devices 130. In an alternative embodiment, database 120 is stored remotely from risk evaluation computer system 110 and may be non-centralized.

Database 120 may include a single database having separated sections or partitions, or may include multiple databases, each being separate from each other. Database 120 may store information related to the evaluation of risk factors for secondary hyperparathyroidism including estimating equations, simulation algorithms, and statistical data on the incidence and correlations of SHPT with other potential patient characteristics. However, database 120 does not store any information related to the identity or individual history of any particular patient.

In the example embodiment, one of mobile computing devices 130 may be associated with a particular health care provider while another one of mobile computing devices 130 may be associated with a clinic or other facility. Accordingly, mobile computing devices 130 may be used by any health care provider, health care facility, or other entity that may access risk evaluation computer system 110 to evaluate secondary hyperparathyroidism risk factors. Risk evaluation computer system 110 may be associated with a health care provider such as a doctor, a clinic, or a hospital. Alternately, risk evaluation computer system 110 may be associated with a health care network, a research entity, or a health care evaluation and diagnostics organization.

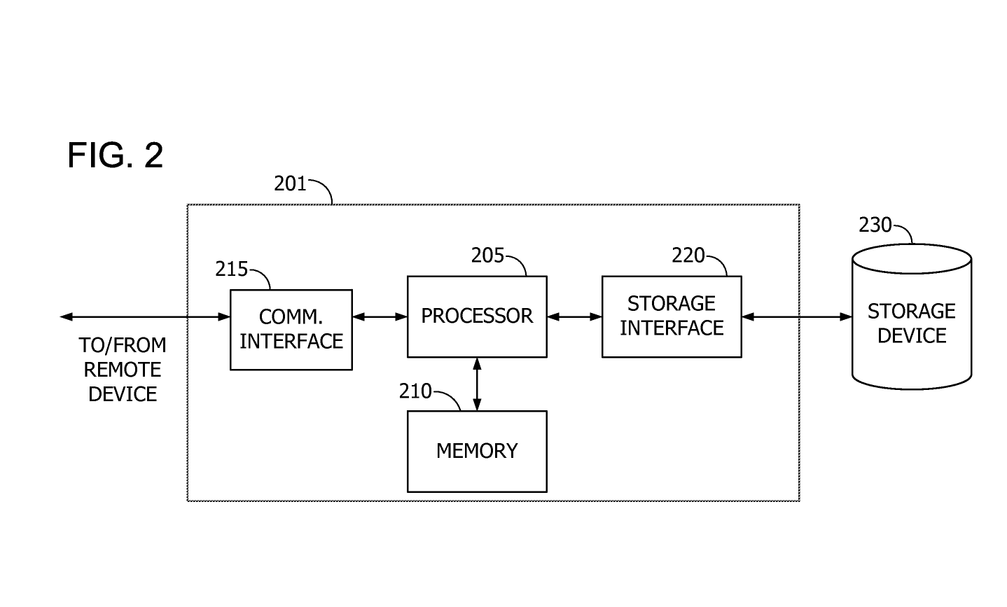

FIG. 2 illustrates an example configuration of a server system 201 such as risk evaluation computer system 110 (shown in FIG. 2), used for evaluating secondary hyperparathyroidism risk factors, as shown in system 100 (shown in FIG. 1). In the example embodiment, server system 201 is configured to perform the steps of (a) receiving, from a mobile computing device, a plurality of demographic data associated with a patient, (b) receiving, from the mobile computing device, a concentration of a renal filtration marker associated with the patient, and (c) determining at least one SHPT risk factor for the patient based on the plurality of demographic data and the concentration of the renal filtration marker using at least one estimating equation, the SHPT risk factor indicating a likelihood that the patient has SHPT, as described herein, as described below.

Server system 201 includes a processor 205 for executing instructions. Instructions may be stored in a memory area 210, for example. Processor 205 may include one or more processing units (e.g., in a multi-core configuration) for executing instructions. The instructions may be executed within a variety of different operating systems on the server system 201, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 205 is operatively coupled to a communication interface 215 such that server system 201 is capable of communicating with a remote device such as a user system or another server system 201. For example, communication interface 215 may receive requests from mobile computing device 130 via network 105 (both shown in FIG. 1).

Processor 205 may also be operatively coupled to a storage device 230. Storage device 230 is any computer-operated hardware suitable for storing and/or retrieving data. In some embodiments, storage device 230 is integrated in server system 201. For example, server system 201 may include one or more hard disk drives as storage device 230. In other embodiments, storage device 230 is external to server system 201 and may be accessed by a plurality of server systems 201. For example, storage device 230 may include multiple storage units such as hard disks or solid state disks in a redundant array of inexpensive disks (RAID) configuration. Storage device 230 may include a storage area network (SAN) and/or a network attached storage (NAS) system.

In some embodiments, processor 205 is operatively coupled to storage device 230 via a storage interface 220. Storage interface 220 is any component capable of providing processor 205 with access to storage device 230. Storage interface 220 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 205 with access to storage device 230.

Memory area 210 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

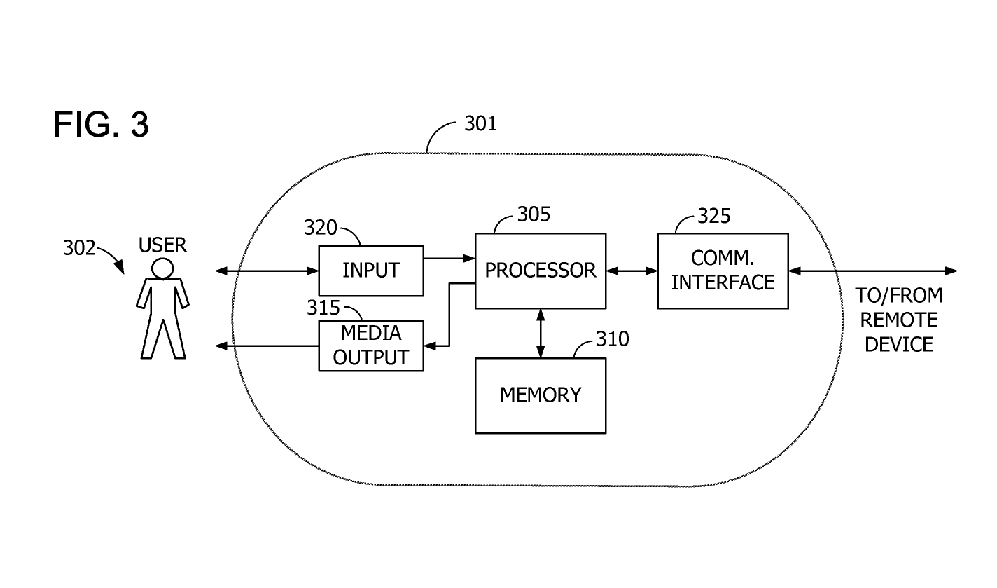

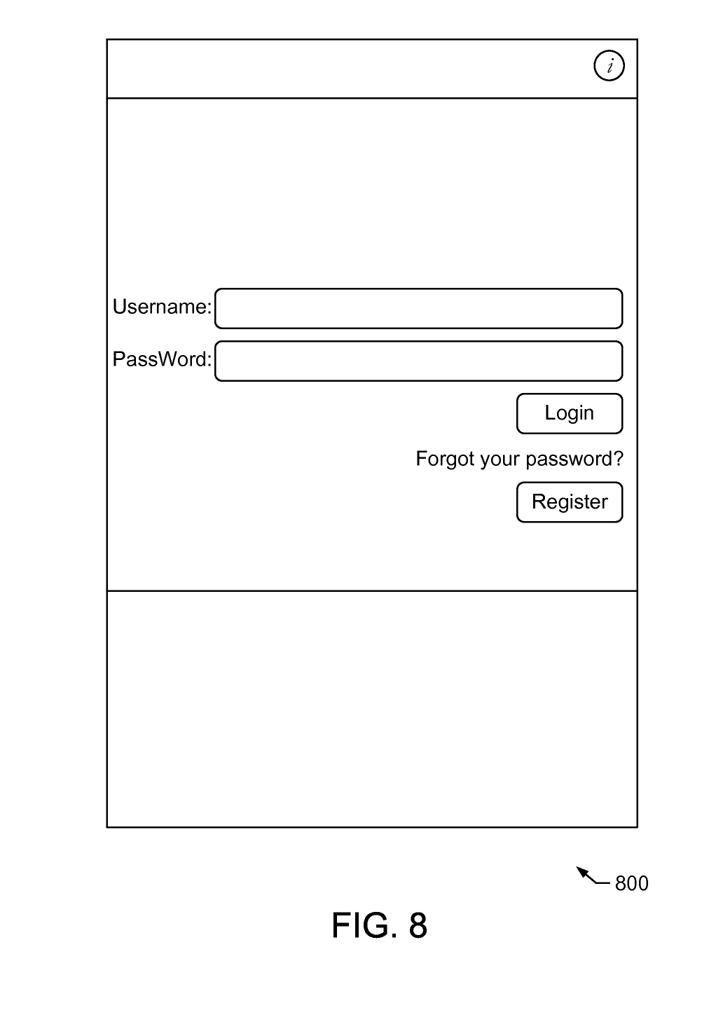

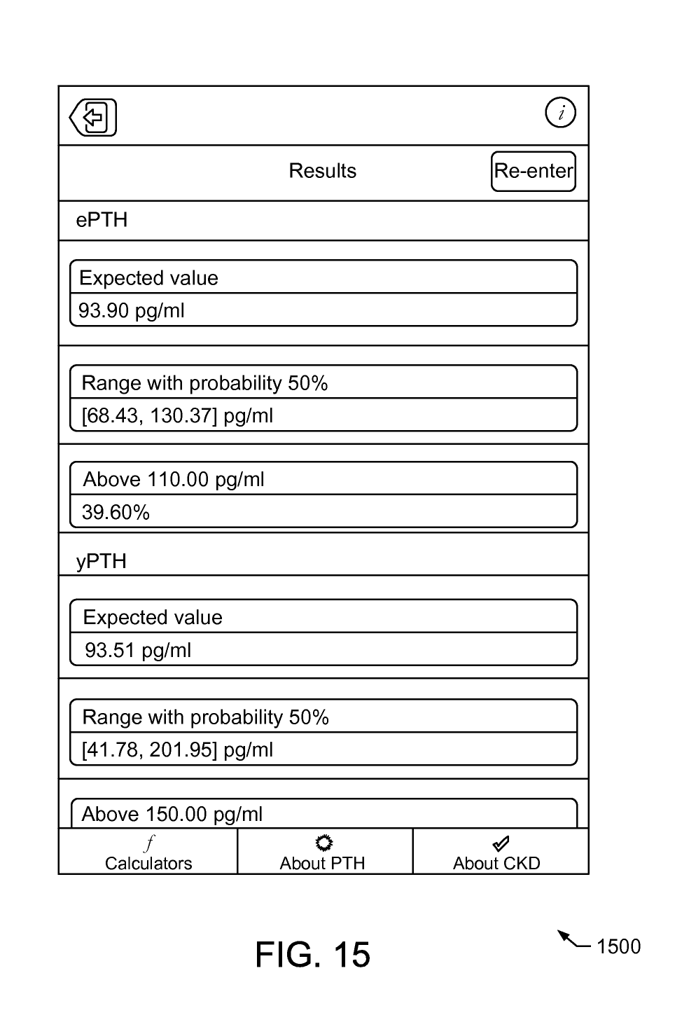

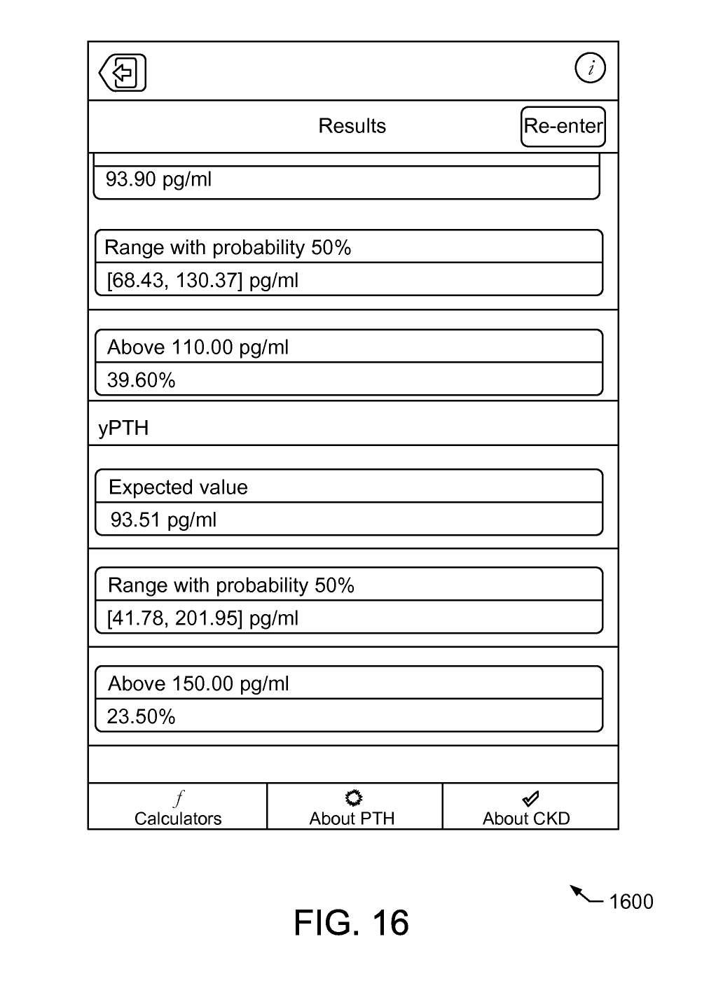

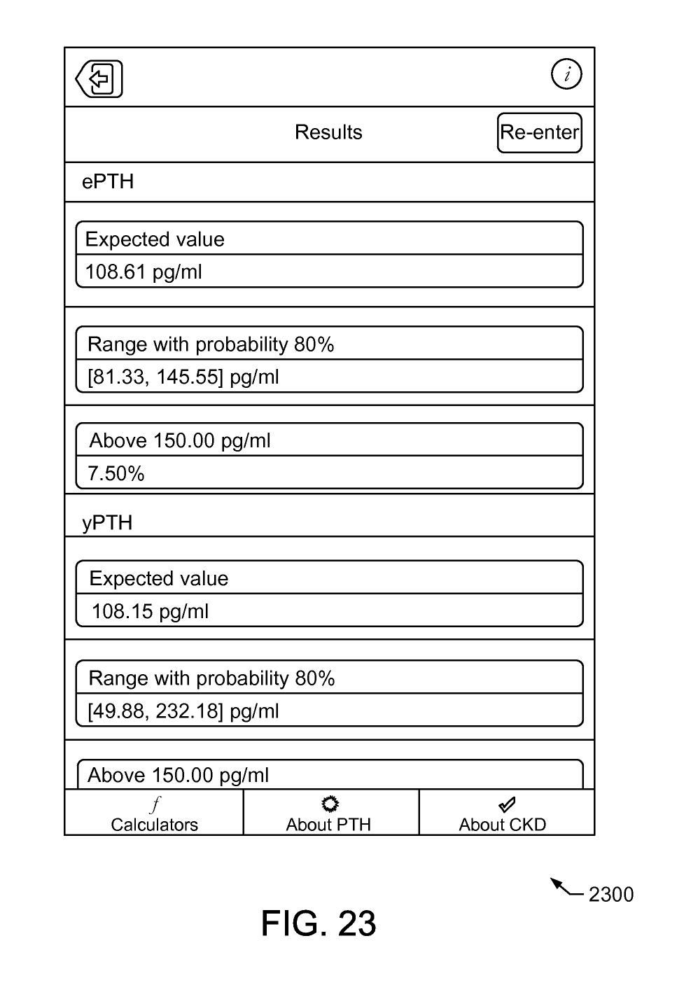

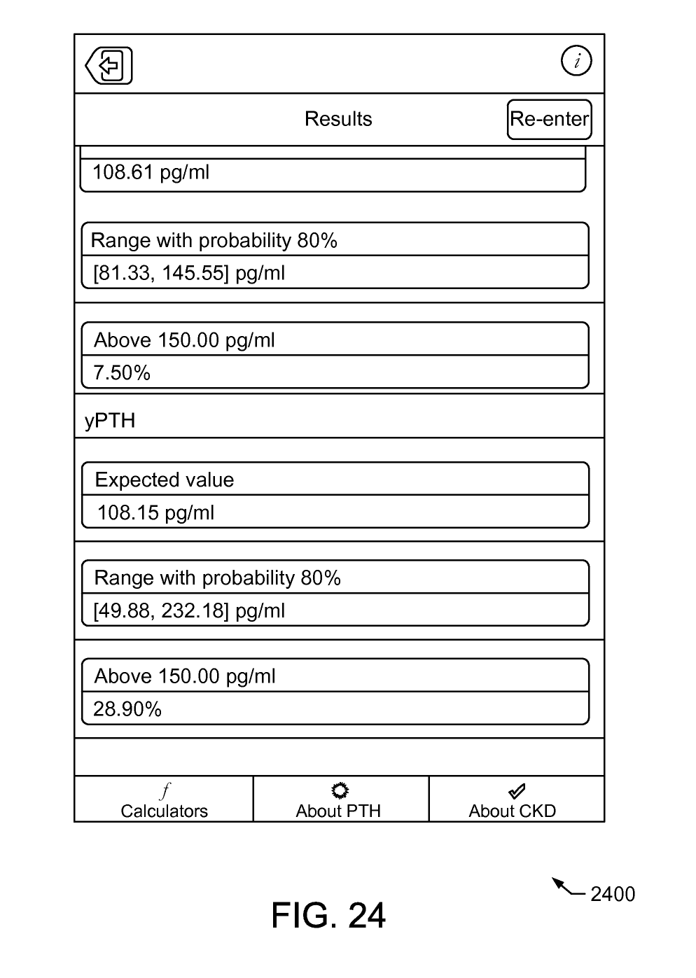

FIG. 3 is a block diagram of a user system 301, such as mobile computing device 130 (shown in FIG. 1), used for evaluating secondary hyperparathyroidism risk factors, as shown in system 100 (shown in FIG. 1). User system 301 may include, but is not limited to, mobile computing device 130. In the example embodiment, user system is configured to (a) receive a plurality of demographic data associated with a patient, (b) receive a concentration of a renal filtration marker associated with the patient, (c) transmit the plurality of demographic data and the concentration of the renal filtration marker to a risk evaluation computer system, and (d) receive at least one SHPT risk factor from the risk evaluation computer system, the SHPT risk factor indicating a likelihood that the patient has SHPT. Examples of display output associated with at least steps (a)-(d) are illustrated in FIGS. 8-24.

User system 301 may be used by a user 302. In the example embodiment, user 302 is a health care provider assessing a patient (not shown) and evaluating the patient for secondary hyperparathyroidism risk factors. In alternative embodiments, user 302 is any other member of a health care organization assessing a patient and evaluating the patient for SHPT. In some alternative embodiments, user 302 is a Laboratory Information Management System (LIMS) that operates on the output of an auto-analyzer that has measured concentrations of renal filtration markers. Accordingly, rather than the health care provider receiving the renal filtration markers concentration report (from the LIMS) and using user system 301, the health care provider orders the calculations described in this patient in the LIMS which tasks user system 301 for the relevant calculations. In further alternative embodiments, user 302 may be a Point of Care Testing Device (POC) that directly measures concentrations of renal filtration markers and passes the result to user system 301. In both of the preceding embodiments, user system 301 is classified as an In Vitro Diagnostic (IVD) by both the FDA and the EMEA and can be released as a standalone product. In the example embodiment, user system 301 includes a processor 305 for executing instructions. In some embodiments, executable instructions are stored in a memory area 310. Processor 305 may include one or more processing units, for example, a multi-core configuration. Memory area 310 is any device allowing information such as executable instructions and/or written works to be stored and retrieved. Memory area 310 may include one or more computer readable media.

User system 301 also includes at least one media output component 315 for presenting information to user 302. Media output component 315 is any component capable of conveying information to user 302. In some embodiments, media output component 315 includes an output adapter such as a video adapter and/or an audio adapter. An output adapter is operatively coupled to processor 305 and operatively couplable to an output device such as a display device, a liquid crystal display (LCD), organic light emitting diode (OLED) display, or “electronic ink” display, or an audio output device, a speaker or headphones.

In some embodiments, user system 301 includes an input device 320 for receiving input from user 302. Input device 320 may include, for example, a keyboard, a pointing device, a mouse, a stylus, a touch sensitive panel, a touch pad, a camera, a touch screen, a gyroscope, an accelerometer, a position detector, or an audio input device. Input device 320 may be used to receive input such as patient related data, records or charts, scanned information, manually typed or entered input, and any other suitable information. A single component such as a touch screen may function as both an output device of media output component 315 and input device 320. User system 301 may also include a communication interface 325, which is communicatively couplable to a remote device such as risk evaluation computer system 110. Communication interface 325 may include, for example, a wired or wireless network adapter or a wireless data transceiver for use with a mobile phone network, Global System for Mobile communications (GSM), 3G, or other mobile data network or Worldwide Interoperability for Microwave Access (WIMAX). Communication interface 325 may further include, any suitable hardware or software for communicating with a network 105 (shown in FIG. 1) such as a hospital or clinic network.

Stored in memory area 310 are, for example, computer readable instructions for providing a user interface to user 302 via media output component 315 and, optionally, receiving and processing input from input device 320. A user interface may include, among other possibilities, a web browser and client application. Web browsers enable users, such as user 302, to display and interact with media and other information typically embedded on a web page or a website from risk evaluation computer system 110. A client application allows user 302 to interact with a server application from risk evaluation computer system 110.

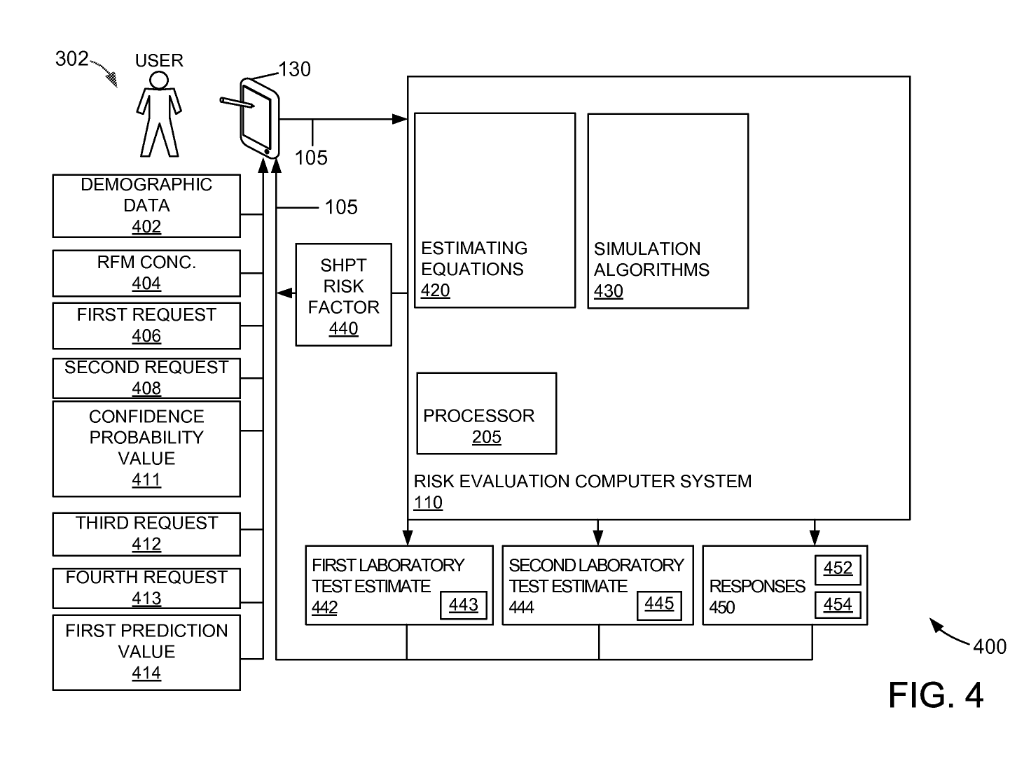

FIG. 4 is an example data flow diagram 400 illustrating the determination of secondary hyperparathyroidism (“SHPT”) risk factors using system 100 (shown in FIG. 1). In the example embodiment, user 302 accesses software associated with the evaluation of SHPT risk factors from mobile computing device 130. The software facilitates the input of information relevant to the evaluation of a patient for SHPT risk factors, the configuration of analysis performed regarding such inputted information, interaction and communication with risk evaluation computer system 110, receipt of information related to the revaluation of SHPT risk factors from risk evaluation computer system 110, and the display of such information. Accordingly, mobile computing device 130 is configured to carry out such steps. The software may be stored as computer-readable storage on mobile computing device 130 at, for example, memory 310 (shown in FIG. 3). In one example, mobile computing device 130 may store the software “locally” on memory 310 as a local application accessible to processor 305 (shown in FIG. 3). In another example, mobile computing device 130 accesses the software from a remote system or a cloud system. User 302 may be required to enter information such as logon information to interact with the software. Such logon information may facilitate securing the software and related data from individuals who are not suitable providers of healthcare services. An example of such a logon screen is shown in FIG. 8 at screenshot 800. User 302 may enter a username and password to ensure that they have suitable credentials to use the software.

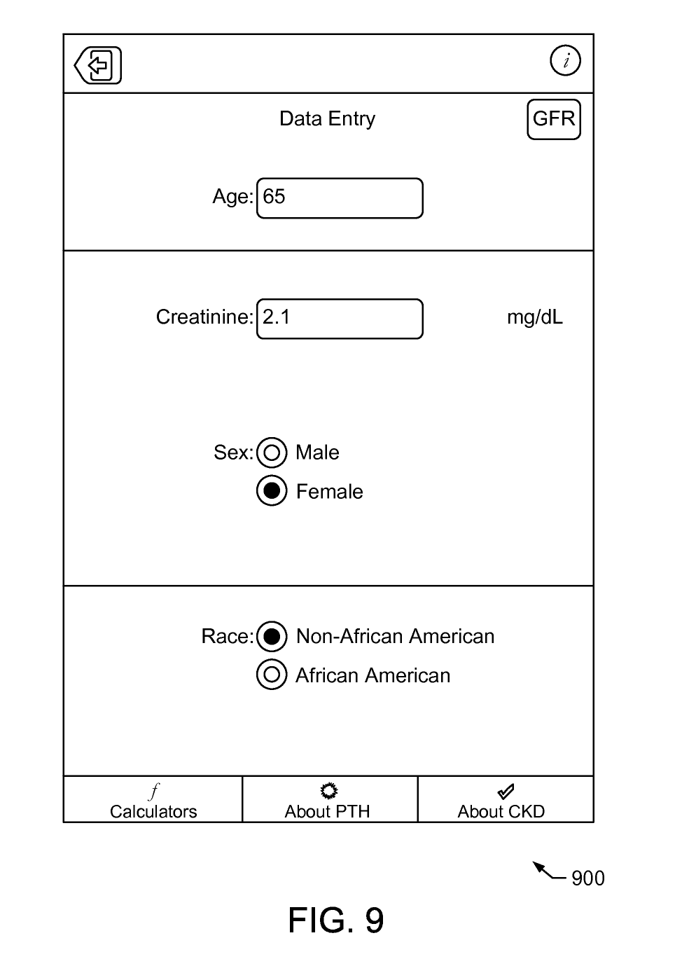

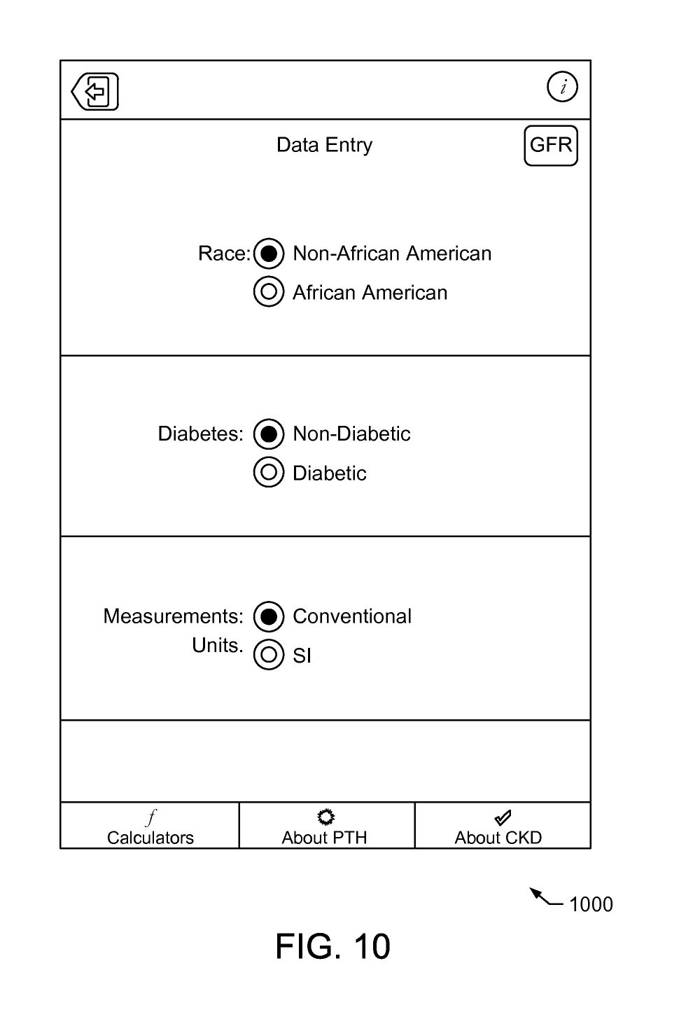

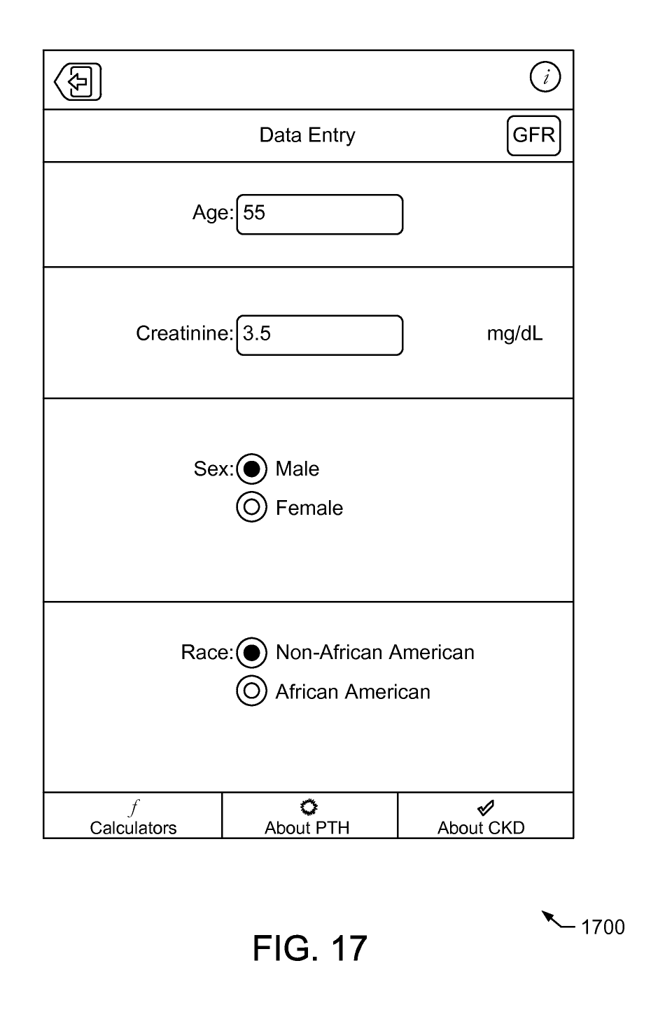

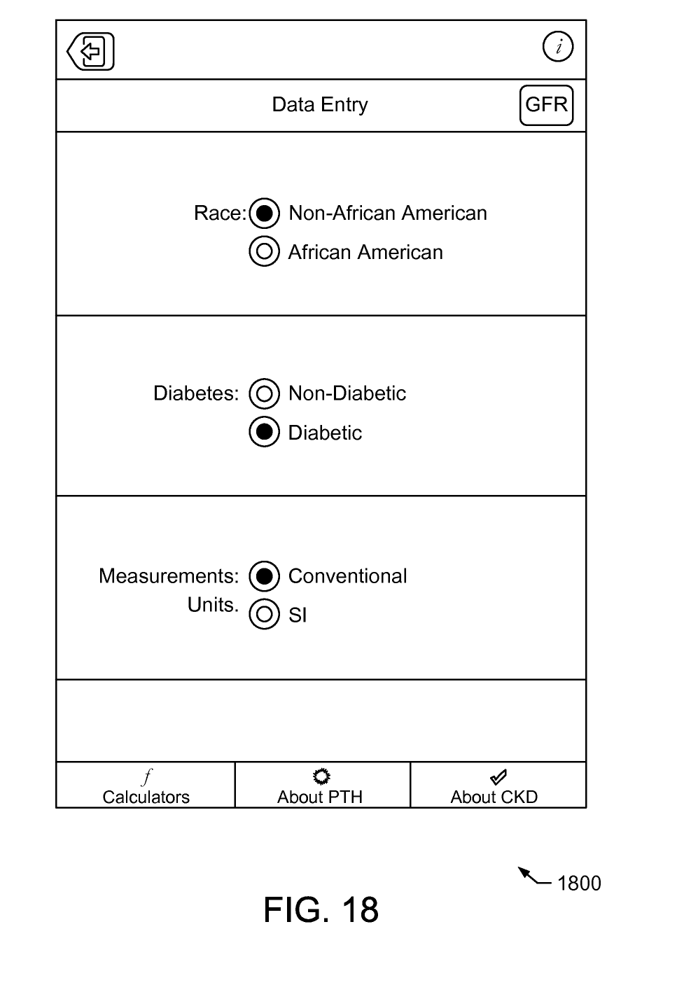

Mobile computing device 130 receives a plurality of demographic data 402 associated with a patient. Plurality of demographic data 402 may include, for example, an age of a patient, a gender of the patient, a race of the patient, and an indication of whether the patient has diabetes. More specifically, the plurality of demographic data 402 may include a text entry for the age of a patient. Additionally, plurality of demographic data 402 may include an indication such as a radio box input selecting whether a patient is male or female. Plurality of demographic data 402 may also include an indication such as a radio box input selecting the racial categorization most closely associated with the patient. In the example embodiment, the racial categorization requires specifying whether a patient is “African American” or “non-African American.” In other examples, other categorizations may be used to the degree that they are relevant to the evaluation of risk factors associated with SHPT. Accordingly, any demographic data may be received and used if information exists to process the relationship between such demographic data and at least one SHPT risk factor. Plurality of demographic data 402 may also include an indication such as a radio box input selecting whether a patient has diabetes or does not have diabetes. Plurality of demographic data 402 is useful in the evaluation of risk factors associated with SHPT because at least some values associated with the example data is correlated to higher or lower incidences of SHPT. In other examples, plurality of demographic data 402 may include any other demographic information that may inform the evaluation of a risk factor for SHPT. FIGS. 9 and 10 illustrate example screenshots 900 and 1000 of the example software collecting and receiving plurality of demographic data 402 for a first patient while FIGS. 17 and 18 illustrate example screenshots 1700 and 1800 of the example software collecting and receiving plurality of demographic data 402 for a second patient.

Mobile computing device 130 also receives a concentration of a renal filtration marker (“RFM Conc.”) 404 associated with a patient. The concentration of a renal filtration marker indicates the concentration of one or more internal renal filtration markers in the blood, plasma, or serum of the patient. Renal filtration markers are small organic molecules or proteins that are generated as a bioproduct of the regular biochemical processes that take place in the body and are subsequently removed from the body by the kidneys. Renal filtration markers may include, for example, creatinine, cystatin-C, beta trace proteins, beta-2-microglobulin, and retinol binding proteins. In the example embodiment, the renal filtration marker is creatinine. Creatinine is a byproduct created during the breakdown of creatine phosphate in human muscle. Creatinine is mainly removed from blood by glomerular filtration performed by kidneys. If such glomerular filtration in the kidney is deficient, creatinine blood levels rise. Accordingly, concentration of a renal filtration marker 404 in blood correlates with the glomerular filtration rate (GFR). Concentrations of a renal filtration marker 404 may also be used along with the plurality of demographic data (age, gender and racial characterization) to calculate an estimated GFR (eGFR). As discussed above and herein, GFR and eGFR are useful for the evaluation of risk factors associated with SHPT. In the example embodiment, user 302 may input a concentration of a renal filtration marker 404 in a numeric format. More specifically, the user inputs the concentration of a renal filtration marker in milligrams per deciliter. FIG. 9 illustrates an example screenshot 900 of the example software collecting and receiving a concentration of a renal filtration marker 404 for a first patient and FIG. 17 illustrates an example screenshot 1700 of the example software collecting and receiving a concentration of a renal filtration marker 404 for a second patient. As any renal filtration marker may indicate the rate of renal filtration, in alternative embodiments, concentrations of any suitable renal filtration may be used including, for example and without limitation, cystatin-C, beta trace proteins, beta-2-microglobulin, and retinol binding proteins.

In at least some embodiments, mobile computing device 130 additionally receives a first request 406 for the calculation of at least one first laboratory test estimate. In one embodiment, first request 406 is a request for the calculation of an index of renal function and a first degree of uncertainty. In at least one example, first request 406 is, more specifically, a request for the calculation of at least one glomerular filtration rate. In such examples, the glomerular filtration rate may include an iothalamate GFR (iGFR), and an estimated glomerular filtration rate (eGFR). As used herein, iGFR and eGFR may accordingly function as an SHPT risk factor and be reviewed by a healthcare provider to determine the risk of SHPT for the patient. The first degree of uncertainty represents a predicted probability of the accuracy of the first laboratory test estimate. This degree of uncertainty is estimated from the Berkson measurement error model that relates eGFR to iGFR. As used herein, the Berkson measurement error model refers to a model of identifying and classifying the error of the CKD Epi formula to account for such erroneous estimates in calculations.

In some embodiments, mobile computing device 130 also receives a second request 408 for the calculation of at least one second laboratory test estimate. In one embodiment, second request 408 is a request for the calculation of a risk factor associated with secondary hyperparathyroidism and a second degree of uncertainty. In at least one example, second request 408 is, more specifically, a request for the calculation of at least one of a first estimated calculation of a blood concentration parathyroid hormone (ePTH) and a second estimated blood concentration of parathyroid hormone (yPTH). As used herein, ePTH and yPTH may accordingly function as an SHPT risk factor and be reviewed by a healthcare provider to determine the risk of SHPT for the patient. The ePTH is the estimated level of the parathyroid hormone that the app computes based on applying a Berkson measurement error model for the eGFR and a spline model for the relationship between iGFR, received patient data (including demographic data), and PTH. yPTH reflects a predicted level of the parathyroid hormone based on the use of a statistical error model on ePTH. The second degree of uncertainty represents a predicted probability of the accuracy of the second laboratory test estimate. As used herein, the statistical error model refers to a model of identifying and classifying measurement error to account for such errors in the calculations.

In at least some examples, user 302 may want to determine whether a patient has a particular likelihood of a particular value (or range of values) for an SHPT risk factor. For example, depending upon the opinion, personal history, and analysis of the user, the user may be concerned with whether the SHPT risk factor is likely to be above or below a certain value. This concern may also depend upon previous interaction with and analysis of the patient. Accordingly, mobile computing device 130 receives a third request 412 for a confidence analysis. The confidence analysis is a range of values that the SHPT risk factor may be associated with for a particular degree of confidence. Third request 412 includes a confidence probability value 411 representing the degree of confidence. In other words, user 302 requests to know what the range of an SHPT risk factor is for a confidence probability value 411.

In a second example, user 302 may want to know whether the SHPT risk factor is likely to exceed or fall below a particular threshold. Mobile computing device 130 additionally receives a fourth request 413 for a threshold analysis. Fourth request 413 includes a first prediction value 414. Fourth request 413 is a request for the probability that an SHPT risk factor exceeds or falls below first prediction value 414. In some examples, fourth request 413 may also include an indicator that the SHPT risk factor only exceed or fall below first prediction value 414. For example, a user may provide that they only want to know the probability that a particular value for an SHPT risk factor exceeds a threshold or to know the probability that a particular value for an SHPT risk factor falls below a threshold.

As described herein, third request 412 and fourth request 413 may apply to any SHPT risk factor. In other words, third request 412 and fourth request 413 (and, accordingly, confidence and threshold analyses) may be used for analyses of eGFR, iGFR, ePTH, yPTH, and any other risk factor associated with SHPT.

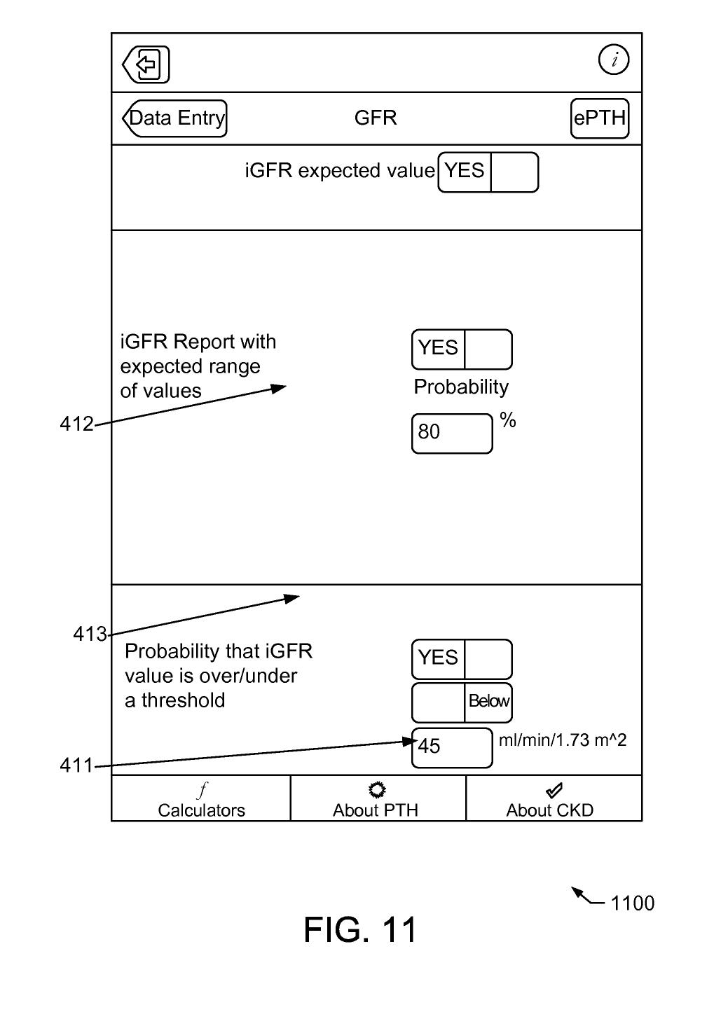

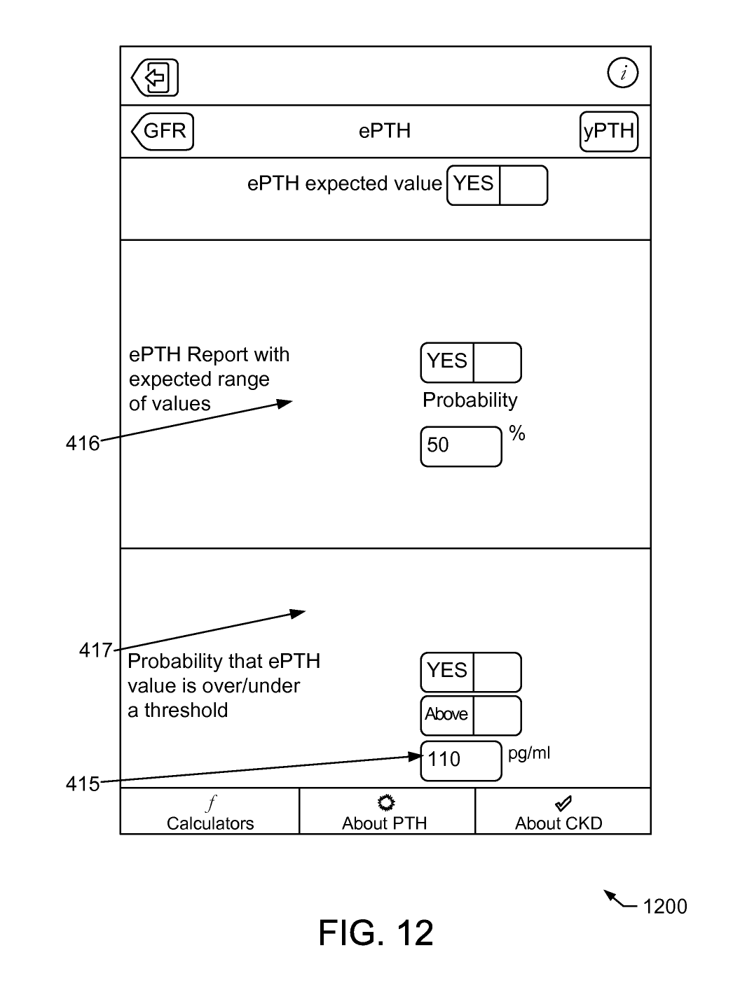

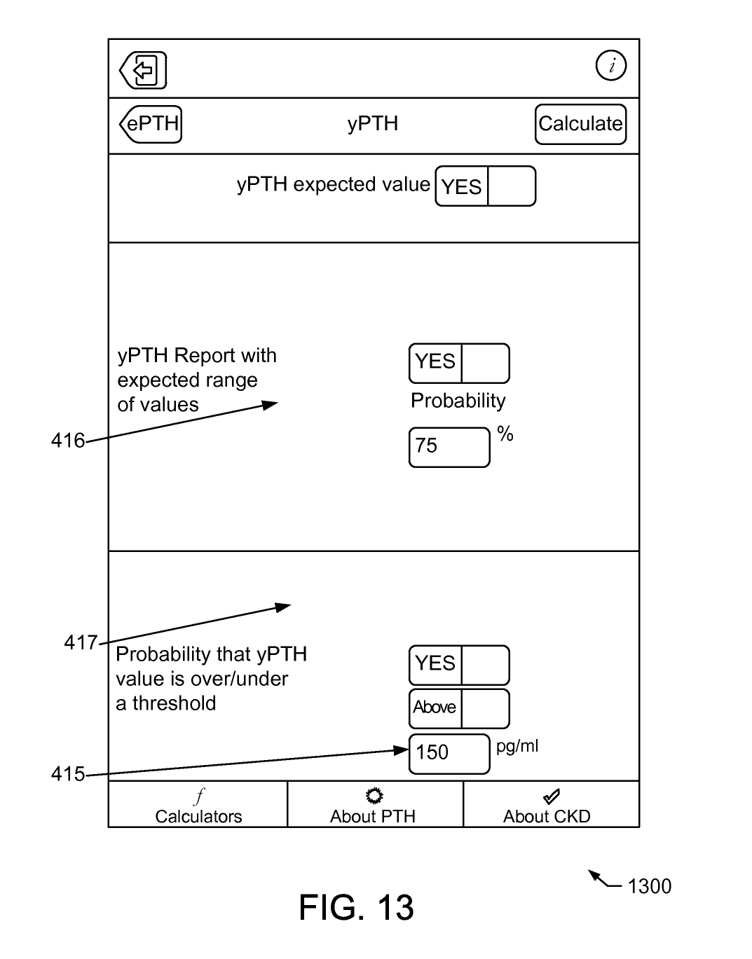

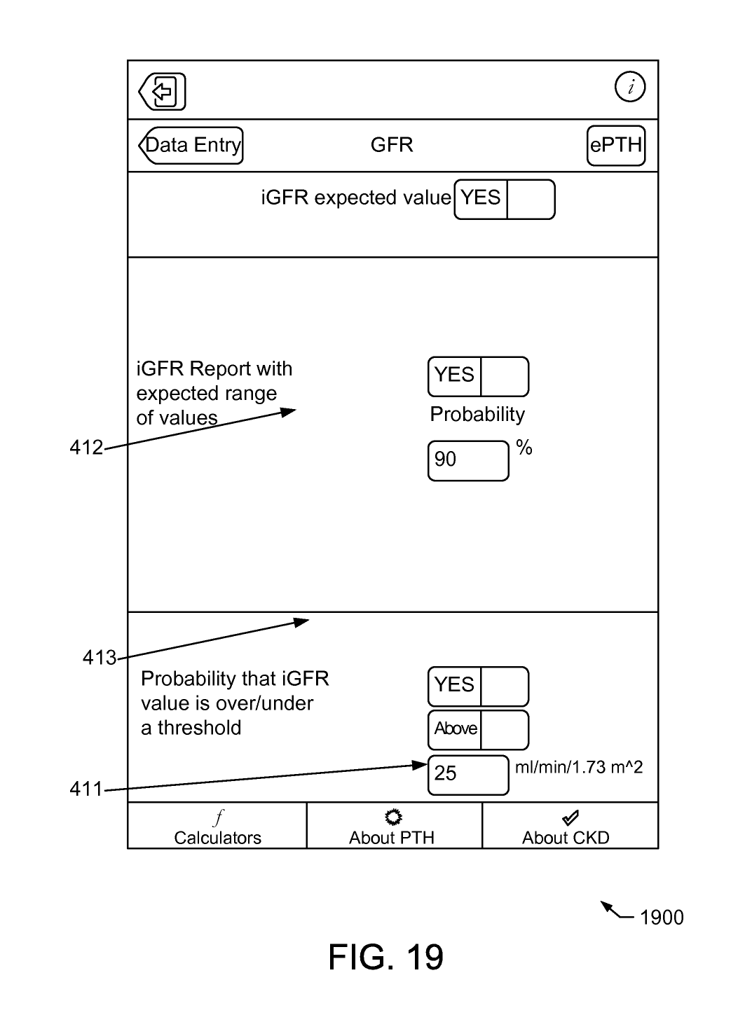

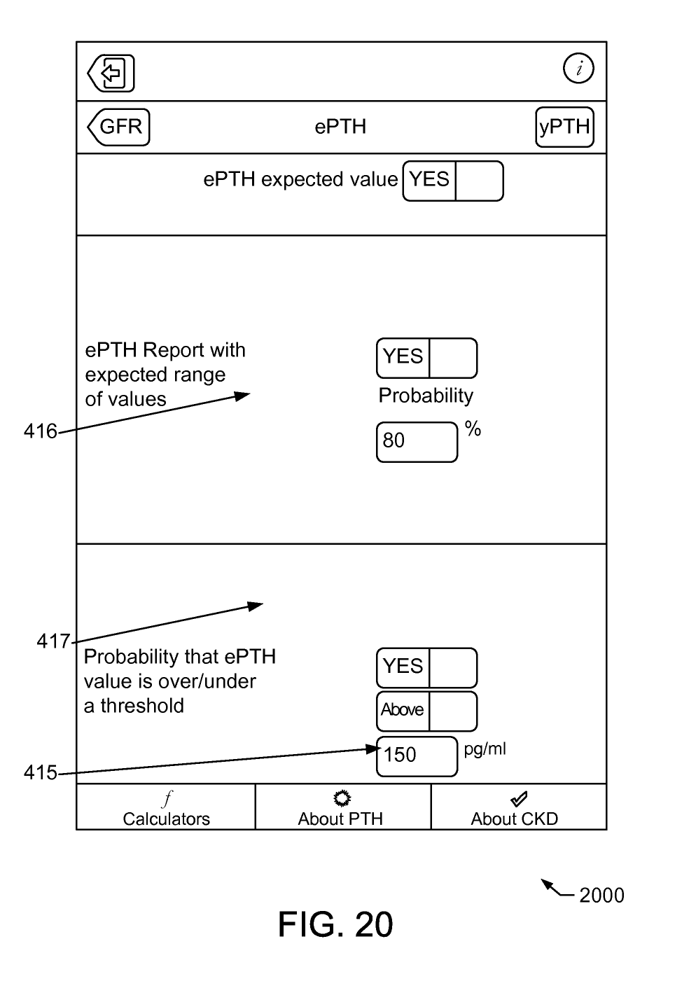

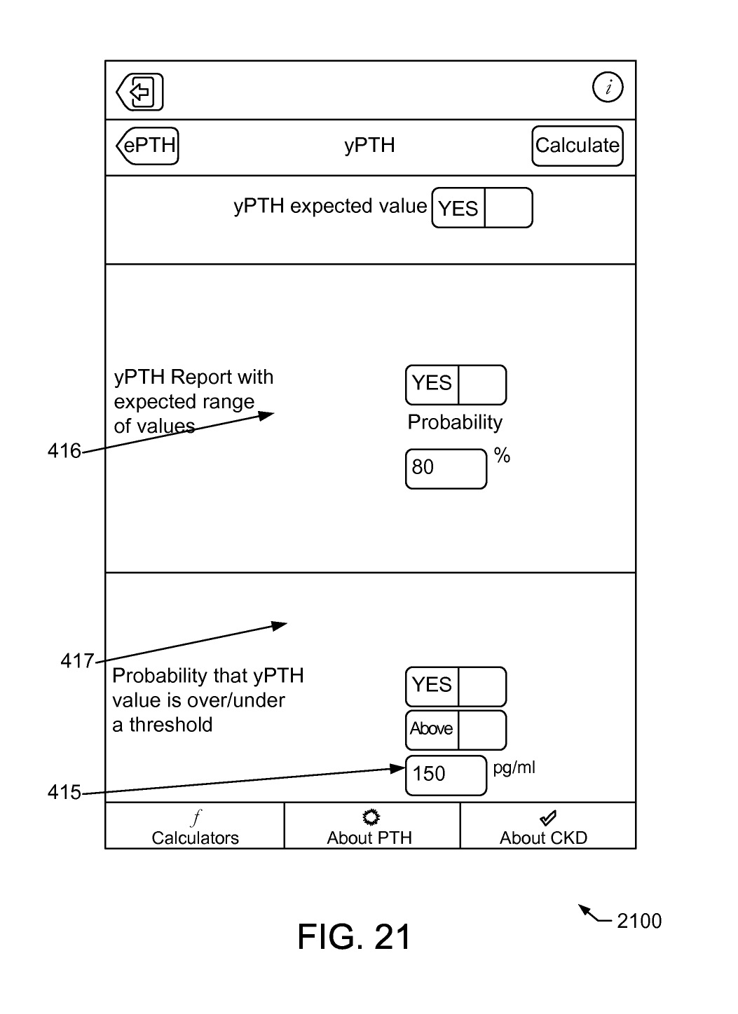

FIG. 11 illustrates an example screenshot 1100 of mobile computing device 130 using software to receive third request 412, fourth request 413, and first prediction value 414 for a first patient. Similarly, FIG. 19 illustrates an example screenshot 1900 of mobile computing device 130 using software to receive third request 412, fourth request 413, and first prediction value 414 for a second patient. In FIGS. 11 and 19, iGFR confidence and threshold analyses are requested. FIGS. 12 and 13 illustrate example screenshots 1200 and 1300 of mobile computing device 130 using software to receive third request 412, fourth request 413, and first prediction value 414 for a first patient for the risk factors of ePTH (in FIG. 12) and yPTH (in FIG. 13). Similarly, FIGS. 20 and 21 illustrate example screenshots 2000 and 2100 of mobile computing device 130 using software to receive third request 412, fourth request 413, and first prediction value 414 for a first patient for the risk factors of ePTH (in FIG. 20) and yPTH (in FIG. 21).

Mobile computing device 130 further transmits all received data to risk evaluation computer system 110. In the example embodiment, mobile computing device 130 transmits plurality of demographic data 402 and concentration of the renal filtration marker 404 associated with the patient. In the example embodiment, such data is transferred securely using network 105 such as the Internet. Accordingly, risk evaluation computer system 110 resultantly receives such data including at least plurality of demographic data 402 and concentration of the renal filtration marker 404 associated with the patient. In at least some examples, risk evaluation computer system 110 receives first request 406, second request 408, third request 412, fourth request 413, confidence probability value 411, and first prediction value 414.

Risk evaluation computer system 110 determines at least one SHPT risk factor 440 for the patient based on plurality of demographic data 402 and concentration of the renal filtration marker 404 using at least one estimating equation 420. In the example embodiment, SHPT risk factor 440 is eGFR. In alternative embodiments, SHPT risk factor 440 may include iGFR, ePTH, or yPTH, as described above and herein. Estimating equation 420 may include any suitable estimating equation. In the example embodiment, estimating equation 420 is the CKD Epi formula used to calculate SHPT risk factor 440 as eGFR. The CKD Epi formula is known in the art and depends upon the relationship between eGFR and serum creatinine is described by a linear spline with a single knot, whose location is determined by gender. In alternative embodiments, estimating equation 420 may be used to determine ePTH and yPTH and may further include the use of a simulation algorithm 430 such as the Markov Chain Monte Carlo stochastic algorithm, described below.

In some examples, risk evaluation computer system 110 determines at least one SHPT risk factor 440 by determining a first laboratory test estimate 442 for renal function and a first degree of uncertainty 443. Accordingly, in such examples, first laboratory test estimate 442 and first degree of uncertainty 443 may be included in SHPT risk factors 440. Such determination is achieved by processing plurality of demographic data 402, concentration of the renal filtration marker 404, and first request 406, using at least one estimating equation 420. In the example embodiment, using estimating equation 420 includes using a Berkson measurement error model for the relationship between the logarithm of the eGFR and the logarithm of the iGFR. In the example embodiment, the Berkson measurement error model gives the values of the bias and the variance parameters for three different ranges of the eGFR: less than 60 ml/min/1.73 m2, 60-89 ml/min/1.73 m2 and greater than 90 ml/min/1.73 m2. In the example embodiment, the estimating equation 420 is the CKD Epi formula used to calculate eGFR. The CKD Epi formula is known in the art and depends upon the relationship between eGFR and serum creatinine is described by a linear spline with a single knot, whose location is determined by gender. In at least some examples, estimating equation 420 also includes a simulation component that estimates a range of plausible values for the log iGFR that are compatible with the given Berkson measurement error model. This simulation component includes a list of random variable values from the three normal (Gaussian) error distributions with bias and variance parameters. This list of variables is added to the log eGFR estimate to yield a list whose elements are the simulated log iGFR values that are compatible with the Berkson measurement error model. In at least some examples, risk evaluation computer system 110 determines at least one of a glomerular filtration rate calculation, a log estimated glomerular filtration rate simulation, an expected value calculation, an uncertainty calculation, and a threshold calculation. However, no such simulations are displayed to a user such as user 302 (shown in FIG. 3). Rather, these simulations occur within estimating equation 420. In further examples, risk evaluation computer system 110 also determines SHPT risk factors 440 by determining a second laboratory test estimate 444 and a second degree of uncertainty 445. Accordingly, in such examples, second laboratory test estimate 444 and second degree of uncertainty 445 may be included in SHPT risk factors 440. Such determination is achieved by processing plurality of demographic data 402, second request 408, first laboratory test estimate 442, and first degree of uncertainty 443 using at least one simulation algorithm 430. In the example embodiment, simulation algorithm 430 is a Markov Chain Monte Carlo stochastic simulation algorithm. The Markov Chain Monte Carlo stochastic algorithm may include any algorithms for sampling from probability distributions based on constructing a Markov chain that has the desired distribution as its equilibrium distribution. The state of the chain after a large number of steps is then used as a sample of the desired distribution. The quality of the sample improves as a function of the number of steps. The Markov Chain Monte Carlo stochastic simulation algorithm relates plurality of demographic data 402, iGFR estimate of renal function, and PTH based upon measurements of demographic data 402, iGFR estimates, and PTH in actual patients. More specifically, the Markov Chain Monte Carlo stochastic algorithm is created based on the determined statistical relationship between demographic data 402, iGFR estimates, and PTH. The data for this analysis was retrieved in a sponsored epidemiological study. A linear regression model was assumed in order to generate PTH measurements such that the actual (measured) log PTH was created as the sum of seven Elements:
1. An additive correction for the effects of diabetes on PTH.
2. An additive correction for the effects of gender on PTH.
3. A linear spline component with 4 knots for the effect of increasing age on PTH.
4. A linear spline component with 4 knots for the effect of decreasing log iGFR on PTH.
5. An interaction term between the spline component of log iGFR and diabetes. The meaning of this interaction term is that the relationship between log iGFR and PTH is different in patients with and patients without diabetes in accordance with the medical knowledge of SHPT.
6. An interaction term between the spline component of log iGFR and gender. The meaning of this interaction term is that the relationship between log iGFR and PTH is different in female and male patients in accordance with the medical knowledge of SHPT.
7. An error component assumed to have zero bias and measurement bias.

It should be noted that the relation between the renal function index and log PTH is at the level of the log iGFR not the level of log eGFR. As such, the Berkson measurement error model is used in this context again. Elements 1-7 resolve the log PTH value of a given patient to contributions due to renal function, gender, diabetes and include both unknown (“coefficients”) and known (knots) components. The location of the knots for the spline components of age and log iGFR are given the following table (Table 3):

| Log iGFR Knots | Age Knots |
|---|---|
| 3.09921708554534 | 54.6913073237509 |
| 3.46066886021437 | 66.2915811088296 |
| 3.75924193660498 | 72.539356605065 |
| 4.04628035851206 | 77.7084188911704 |

A Bayesian approach was adopted wherein the probability distribution of the coefficients that give numerical substance to Elements 1-7 were estimated from the available source data. The probability distribution codifies the uncertainty that a given value for a coefficient corresponds to the true, unknown, state of the world that generates log PTH values. This probability distribution is not available in closed expression form, but is approximated by independent samples from a Markov Chain constructed so as its equilibrium distribution is the desired one. Each sample thus constructed contains a single value for each of the coefficients in Elements 1-7. This construction was made by constructing a Markov Chain whose equilibrium distribution is the desired one by Monte Carlo integration techniques known in art. The random samples generated by the Markov Chain Monte Carlo method are utilized in simulation algorithm 430. In at least some examples, risk evaluation computer system 110 determines a predicted parathyroid hormone level, an estimated parathyroid hormone level, an expected value calculation, an uncertainty calculation, and a threshold calculation.

Simulation algorithm 430 is used to determine a list of simulated log PTH values from plurality of demographic data 402. First, simulation algorithm 430 tasks the simulation component of the estimating equations 420 to produce a simulation list of log iGFR value. Subsequently, simulation algorithm 430 iterates over all the samples of the Markov Chain Monte Carlo, adding together the contributions of Elements 1-7 that correspond to the plurality of demographic data 402 provided and the log iGFR, with the latter embodying the estimate of the renal function index and its uncertainty as determined by plurality of the demographic data 402, and the Berkson measurement error model. In this iterative simulation scheme, restricting the contribution to only the first six elements corresponds to a simulation for the log ePTH, while using all seven reflects the log yPTH. The simulation lists thus generated may be used to provide an expected value, an uncertainty and a threshold calculation.

In examples wherein mobile computing device 130 receives requests for confidence analyses associated with third request 412 or threshold analyses associated with fourth request 413, risk evaluation computer system 110 performs such confidence and threshold analyses. More specifically, risk evaluation computer system 110 determines third response 452 for a confidence analysis including a range of values within which the SHPT risk factor is contained associated with a particular confidence probability value 411. Risk evaluation computer system 110 also determines a fourth response 454 for a threshold analysis including a probability that the SHPT risk factor or falls below first prediction value 414.

Risk evaluation computer system 110 also provides at least one SHPT risk factor 440 to mobile computing device 130. Accordingly, in some examples, risk evaluation computer system 110 further provides first laboratory test estimate 442 and first degree of uncertainty 443 to mobile computing device 130 and also provides second laboratory test estimate 444 and second degree of uncertainty 445 to mobile computing device 130. Providing at least one SHPT risk factor 440 to mobile computing device 130 represents transmitting such information to mobile computing device 130. In the example embodiment, the information is transmitted over network 105 such as the Internet. Accordingly, in the example embodiment, mobile computing device 130 receives at least one SHPT risk factor 440. In other embodiments, mobile computing device 130 also receives first laboratory test estimate 442 and first degree of uncertainty 443 as well as second laboratory test estimate 444 and second degree of uncertainty 445.

In at least some examples, risk evaluation computer system 110 also transmits additional information as responses 450. Such additional information may include third response 452 for a confidence analysis including a range of values within which the SHPT risk factor is contained associated with a particular confidence probability value 411. Third response 452 is transmitted in examples where the mobile computing device 130 transmits third request 412 for a confidence analysis. Such additional information may also include fourth response 454 for a threshold analysis including probability that the SHPT risk factor or falls below first prediction value 414. Fourth response 454 is transmitted in examples where mobile computing device 130 transmits fourth request 413 for a threshold analysis.

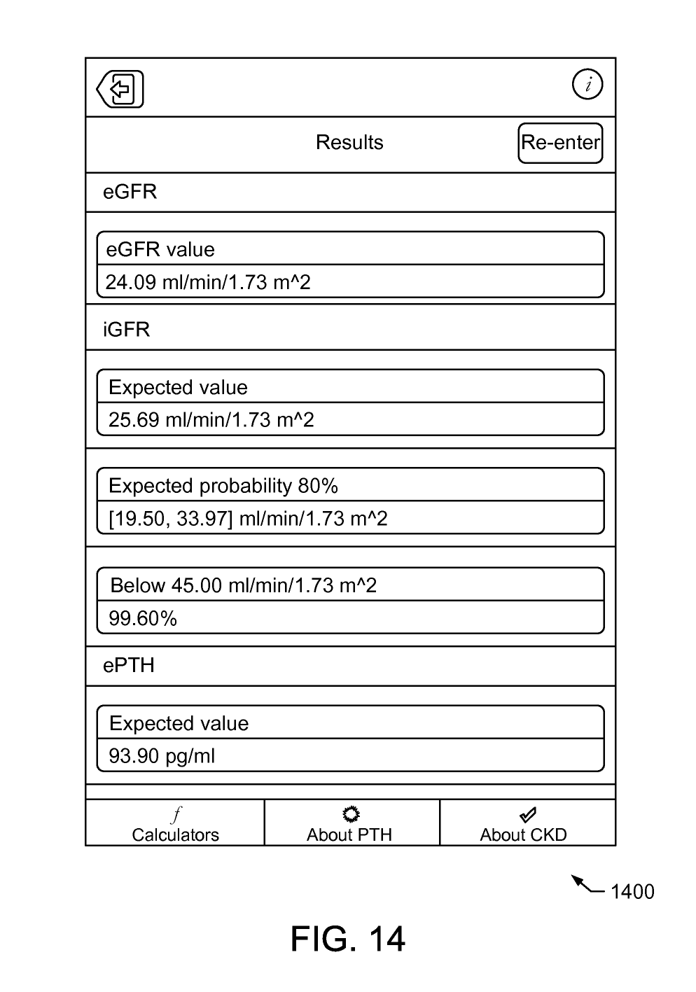

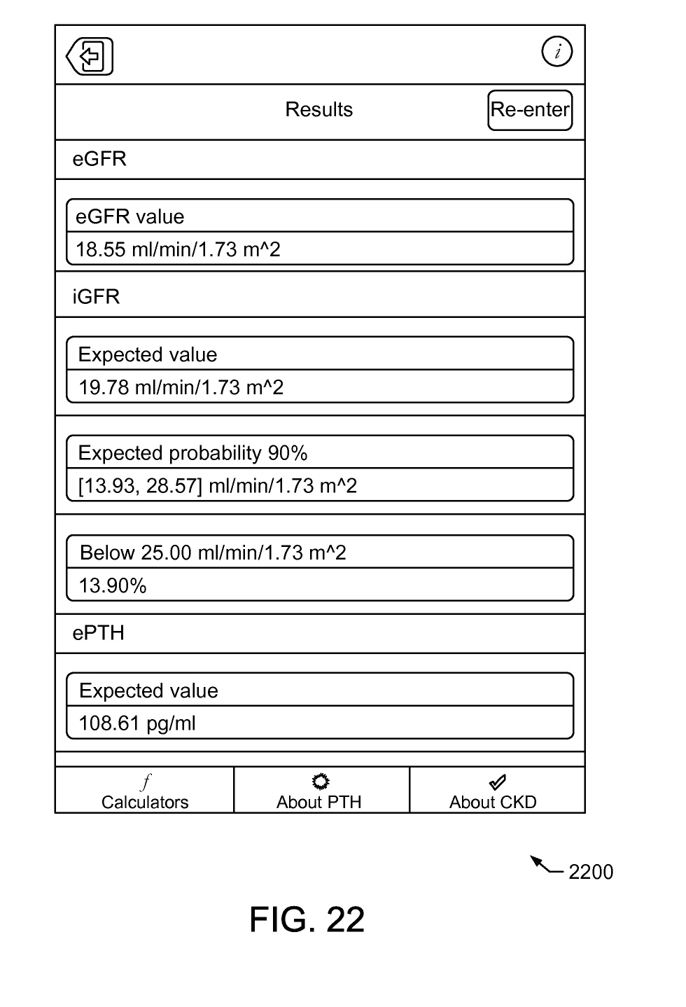

Mobile computing device 130 displays, to user 302, at least one SHPT risk factor 440. In some examples, mobile computing device 130 also displays first laboratory test estimate 442 and first degree of uncertainty 443 and second laboratory test estimate 444 and second degree of uncertainty 445. Such information is displayed on at least one display of the mobile computing device. In at least some examples, the mobile computing device also displays at least one of the third response 452, and fourth response 454. FIGS. 14, 15, and 16 illustrate screenshots 1400, 1500, and 1600 showing displayed output associated with SHPT risk factors including first laboratory test estimate 442, first degree of uncertainty 443, second laboratory test estimate 444, second degree of uncertainty 445, third response 452 and fourth response 454 for a first patient. Similarly, FIGS. 22, 23, and 24 illustrate screenshots 2200, 2300, and 2400 showing displayed output associated with SHPT risk factors including first laboratory test estimate 442, first degree of uncertainty 443, second laboratory test estimate 444, second degree of uncertainty 445, third response 452, and fourth response 454 for a second patient.

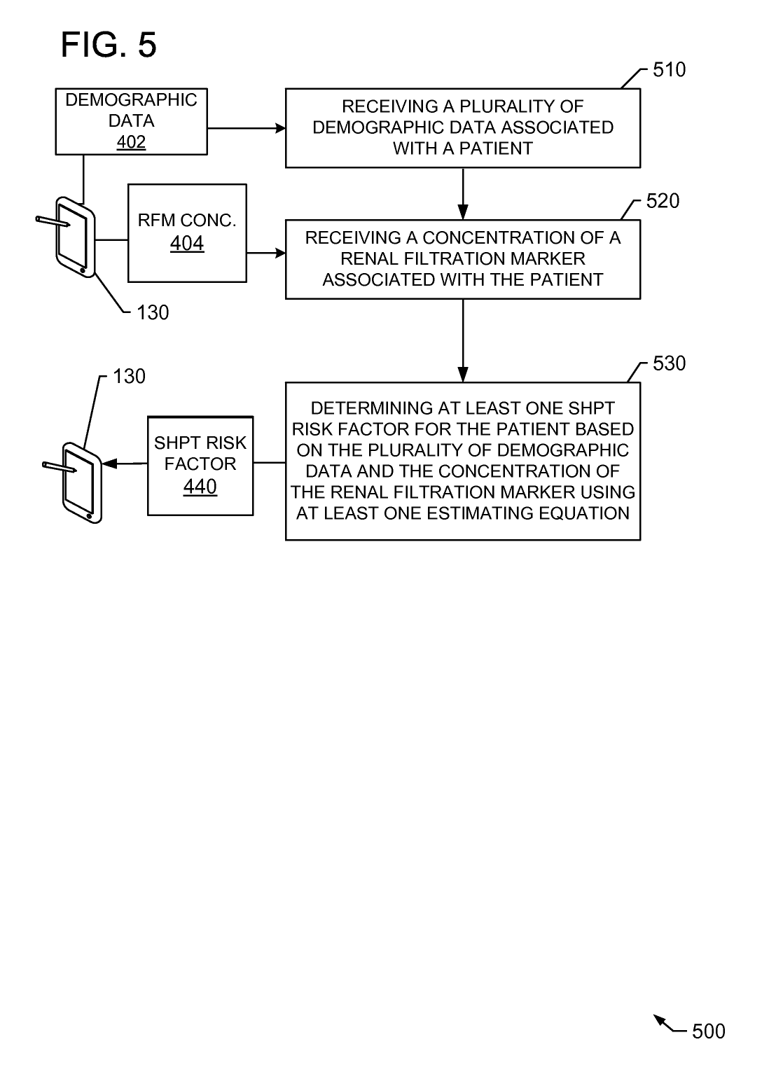

FIG. 5 is an example method 500 for determining secondary hyperparathyroidism risk factors performed by the risk evaluation computer system 110 and using system 100 (shown in FIG. 1). Risk evaluation computer system 110 receives 510 a plurality of demographic data associated with a patient. Receiving 510 represents risk evaluation computer system 110 receiving plurality of demographic data 402 from mobile computing device 130.

Risk evaluation computer system 110 also receives 520 a concentration of a renal filtration marker associated with the patient. Receiving 520 represents risk evaluation computer system 110 receiving concentration of a renal filtration marker 404 from mobile computing device 130.

Risk evaluation computer system 110 additionally determines 530 at least one SHPT risk factor for the patient based on the plurality of demographic data and the concentration of the renal filtration marker using at least one estimating equation. Determining 530 represents using at least one estimating equation 420 (shown in FIG. 4) to process plurality of demographic data 402 and concentration of renal filtration marker 404 and determine an SHPT risk factor.

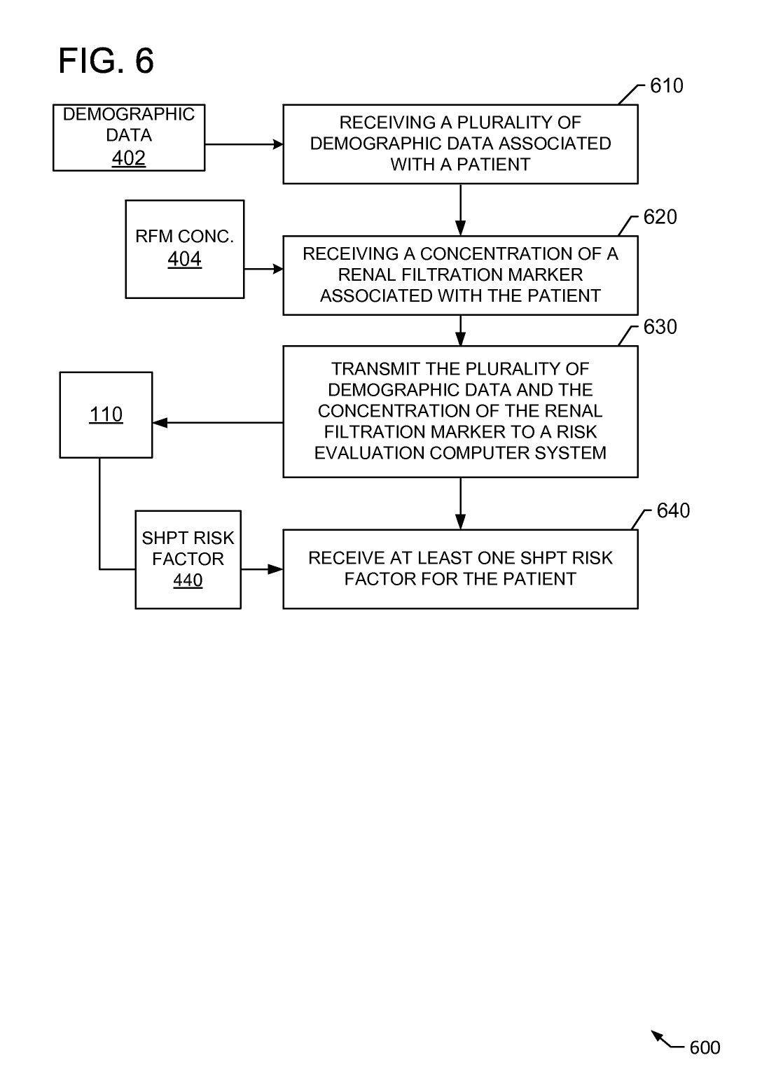

FIG. 6 is an example method 600 for determining secondary hyperparathyroidism risk factors performed by a mobile computing device 130 and using system 100 (shown in FIG. 1). Mobile computing device 130 receives 610 a plurality of demographic data associated with a patient. Receiving 610 represents mobile computing device 130 receiving input from a user such as user 302 (shown in FIG. 3) including plurality of demographic data 402.

Mobile computing device 130 also receives 620 a concentration of a renal filtration marker associated with the patient. Receiving 620 represents mobile computing device 130 receiving input from a user such as user 302 including concentration of renal filtration marker 404.

Mobile computing device 130 also transmits 630 the plurality of demographic data, and the concentration of the renal filtration marker to a risk evaluation computer system. Transmitting 630 represents sending at least plurality of demographic data 402 and concentration of renal filtration marker 404 to risk evaluation computer system 110.

Mobile computing device 130 further receives 640 at least one SHPT risk factor for the patient. Receiving 640 represents mobile computing device 130 receiving SHPT risk factor 440 from risk evaluation computer system 110. Mobile computing device 130 may accordingly display SHPT risk factor 440 on an associated display.

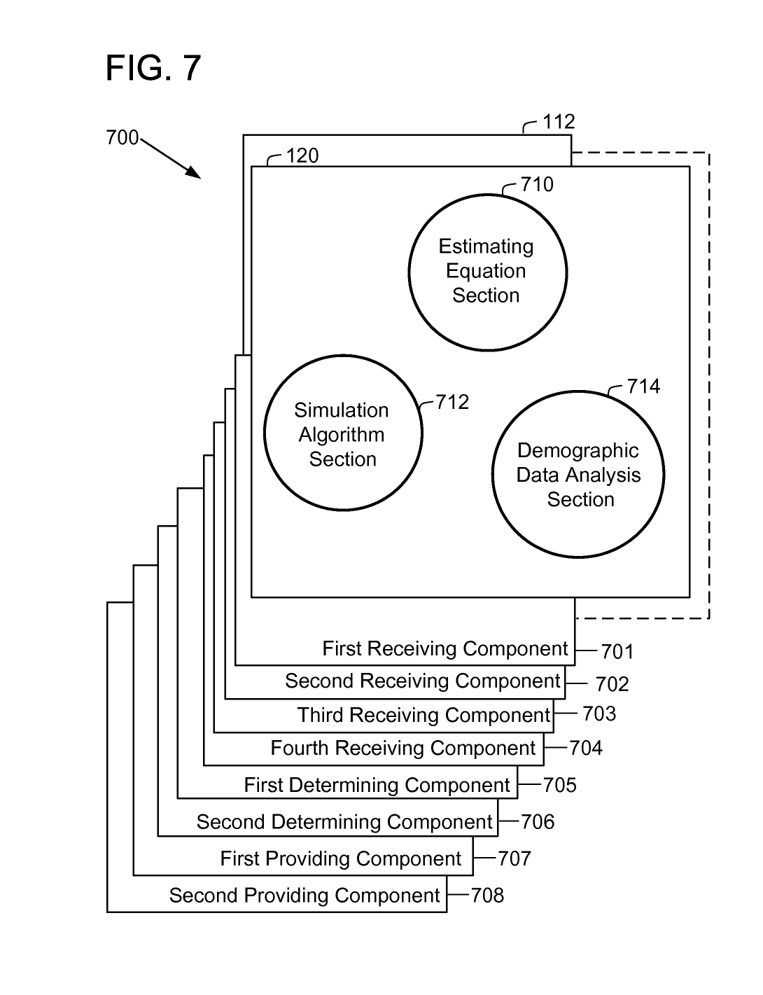

FIG. 7 is a diagram 700 of components of one or more example computing device such as risk evaluation computer system 110 (shown in FIG. 1) that may be used in system 100 (shown in FIG. 1).

FIG. 7 further shows a configuration of database 120. Database 120 is coupled to several separate components within risk evaluation computer system 110, which perform specific tasks.

Risk evaluation computer system 110 includes a first receiving component 701, a second receiving component 702, a third receiving component 703, a fourth receiving component 704, a first determining component 705, a second determining component 706, a first providing component 707, and a second providing component 708.

In an exemplary embodiment, database 120 is divided into a plurality of sections, including but not limited to, an estimating equation section 710, a simulation algorithm section 712, and demographic data analysis section 714. These sections within database 120 are interconnected to update and retrieve the information as required.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the subject matter described herein or its features may have different names, formats, or protocols. Further, the system may be implemented via a combination of hardware and software, as described, or entirely in hardware elements. Also, the particular division of functionality between the various system components described herein is merely for the purposes of example only, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method for determining at least one secondary hyperparathyroidism (SHPT) risk factor for a patient, the method implemented using a risk evaluation computer system in communication with a memory, the method comprising:
receiving a plurality of demographic data associated with a patient;
receiving a concentration of a renal filtration marker associated with the patient; and
determining, by the risk evaluation computer system, at least one SHPT risk factor for the patient based on the plurality of demographic data and the concentration of the renal filtration marker associated with the patient using at least one estimating equation, the SHPT risk factor indicating a likelihood that the patient has SHPT.

2. The method of claim 1, further comprising:
receiving a first request of at least one glomerular filtration rate (GFR); and
determining the at least one SHPT risk factor, wherein the at least one SHPT risk factor includes at least one of an iothalamate GFR (iGFR) and an estimated GFR (eGFR).

3. The method of claim 1, further comprising:
receiving a second request of a parathyroid hormone concentration (PTH); and
determining the at least one SHPT risk factor, wherein the at least one SHPT risk factor includes at least one of an estimated PTH (ePTH) and yPTH.

4. The method of claim 1, further comprising:
receiving a third request for a confidence analysis, wherein the third request includes a confidence probability value; and
determining a third response for the confidence analysis, wherein the third response is range of values of the at least one SHPT risk factors associated with the confidence probability value.

5. The method of claim 1, further comprising:
receiving, by the computer system, a first prediction value for the at least one SHPT risk factor;
receiving a fourth request for a threshold analysis, wherein the fourth request includes the first prediction value;
determining a fourth response for the threshold analysis, wherein the fourth response includes a threshold probability that the at least one SHPT risk factor exceeds or falls below the first prediction value.

6. The method of claim 1, further comprising:
receiving a report including a plurality of values for the at least one SHPT risk factor with a probability for each value.

7. The method of claim 1, wherein receiving the plurality of demographic data associated with the patient further comprises receiving at least one of:
a gender of the patient;
a race of the patient; and
an indication of whether the patient has diabetes.

8. The method of claim 1 wherein determining the at least one SHPT risk factor, further comprises determining at least one of:
a log glomerular filtration rate calculation for the patient;
a log estimated glomerular filtration rate simulation for the patient;
an expected value of the at least one SHPT risk factor;
an uncertainty calculation of the at least one SHPT risk factor; and
a threshold calculation of the at least one SHPT risk factor.

9. The method of claim 1, wherein determining the at least one SHPT risk factor further comprises determining at least one of:
a predicted parathyroid hormone level for the patient;
an estimated parathyroid hormone level for the patient;
an expected value calculation for the patient;
an uncertainty calculation for the patient; and
a threshold calculation for the patient.

10. The method of claim 1 further comprising providing the at least one SHPT risk factor for display on a mobile computing device.

11. A risk evaluation computer system for determining secondary hyperparathyroidism risk factors, the risk evaluation computer system comprising a memory for storing data, and a processor in communication with the memory, said processor programmed to:
receive a plurality of demographic data associated with a patient;
receive a concentration of a renal filtration marker associated with the patient; and
determine at least one SHPT risk factor for the patient based on the plurality of demographic data and the concentration of the renal filtration marker associated with the patient using at least one estimating equation, the SHPT risk factor indicating a likelihood that the patient has SHPT.

12. The risk evaluation computer system of claim 11, wherein the processor is further programmed to:
receive a first request for the calculation of at least one glomerular filtration rate (GFR); and
determine at least one SHPT risk factor, wherein the at least one SHPT risk factor includes at least one of an iothalamate GFR (iGFR) and an estimated GFR (eGFR).

13. The risk evaluation computer system of claim 11, wherein the processor is further programmed to:
receive a second request for the calculation of a parathyroid hormone concentration (PTH); and
determine at least one SHPT risk factor, wherein the at least one SHPT risk factor includes at least one of an estimated PTH (ePTH) and yPTH.

14. The risk evaluation computer system of claim 11, wherein the processor is further programmed to:
receive a third request for a confidence analysis, wherein the third request includes a confidence probability value; and
determine a third response for the confidence analysis, wherein the third response is range of values of the at least one SHPT risk factors associated with the confidence probability value.

15. The risk evaluation computer system of claim 11, wherein the processor is further programmed to:
receive a first prediction value for the at least one SHPT risk factor;
receive a fourth request for a threshold analysis, wherein the fourth request includes the first prediction value;
determine a fourth response for the threshold analysis, wherein the fourth response includes a threshold probability that the at least one SHPT risk factor exceeds or falls below the first prediction value.

16. The risk evaluation computer system of claim 11, wherein the processor is further configured to:
receive a report including a plurality of values for the at least one SHPT risk factor associated with a probability for each value.

17. The risk evaluation computer system of claim 11, wherein the processor is further programmed to receive at least one of:
a gender of the patient;
a race of the patient; and
an indication of whether the patient has diabetes.

18. The risk evaluation computer system of claim 11, wherein the processor is further programmed to determine at least one of:
a log glomerular filtration rate calculation for the patient;
a log estimated glomerular filtration rate simulation for the patient;
an expected value of the at least one SHPT risk factor;
an uncertainty calculation of the at least one SHPT risk factor; and
a threshold calculation of the at least one SHPT risk factor.

19. The risk evaluation computer system of claim 11, wherein the processor is further programmed to determine at least one of:
a predicted parathyroid hormone level for the patient;
an estimated parathyroid hormone level for the patient;
an expected value calculation for the patient;
an uncertainty calculation for the patient; and
a threshold calculation for the patient.

20. The risk evaluation computer system of claim 11, wherein the processor is further programmed to:
provide the at least one SHPT risk factor for display on a mobile computing device.

21. A computer-readable storage device, having processor-executable instructions embodied thereon, for determining secondary hyperparathyroidism (SHPT) risk factors on a mobile computing device, wherein the mobile computing device includes at least one processor and a memory coupled to the processor, wherein, when executed by the mobile computing device, the processor-executable instructions cause the mobile computing device to:
receive a plurality of demographic data associated with a patient;
receive a concentration of a renal filtration marker associated with the patient;
transmit the plurality of demographic data and the concentration of the renal filtration marker to a risk evaluation computer system; and
receive at least one SHPT risk factor.

22. The computer-readable storage device of claim 21, further configured to:
display the at least one SHPT risk factor on a display associated with the mobile computing device.

23. The computer-readable storage device of claim 21, wherein the processor-executable instructions cause the mobile computing device to receive at least one of:
a gender of the patient;
a race of the patient; and
an indication of whether the patient has diabetes.

24. A computer-readable storage device, having processor-executable instructions embodied thereon, for determining secondary hyperparathyroidism (SHPT) risk factors on a risk evaluation computer system, wherein the risk evaluation computer system includes at least one processor and a memory coupled to the processor, wherein, when executed by the risk evaluation computer system, the processor-executable instructions cause the risk evaluation computer system to:
receive a plurality of demographic data associated with a patient;
receive a concentration of a renal filtration marker associated with the patient; and
determine at least one SHPT risk factor for the patient based on the plurality of demographic data and the concentration of the renal filtration marker associated with the patient using at least one estimating equation, the SHPT risk factor indicating a likelihood that the patient has SHPT.
